(19) United States
(12) Patent Application Publication
(10) Pub. No.: US 2014/0026198 A1
(43) Pub. Date: Jan. 23, 2014

(54) INFORMATION PROCESSING APPARATUS AND CONTROL METHOD

(71) Applicant: Kabushiki Kaisha Toshiba, Tokyo (JP)

(72) Inventors: Hiroshi Isozaki, Kawasaki-shi (JP); Jun Kanai, Fuchu-shi (JP); Ryuiti Koike, Kawasaki-shi (JP); Tatsuo Yamaguchi, Kunitachi-shi (JP); Tetsuo Hatakeyama, Tachikawa-shi (JP); Yuki Kanbe, Ome-shi (JP); Jun Ohashi, Ome-shi (JP); Tatsunori Saito, Sagamihara-shi (JP); Satoshi Ozaki, Hamura-shi (JP)

(73) Assignee: Kabushiki Kaisha Toshiba, Tokyo (JP)

(21) Appl. No.: 14/010,870

(22) Filed: Aug. 27, 2013

Related U.S. Application Data
(63) Continuation of application No. PCT/JP2013/057925, filed on Mar. 13, 2013.

(30) Foreign Application Priority Data
Jul. 23, 2012 (JP) 2012-163030

(51) Int. Cl. H04L 29/06

(52) U.S. Cl. CPC H04L 63/10
USPC 726/4

(57) ABSTRACT

According to one embodiment, a control module detects each of a plurality of events. A management module transmits a determination result indicative of one of permission and prohibition of execution of a specific process to the control module when a second event of requesting execution of the specific process is detected before detection of a first event of requesting a connection to a specific external communication device. When the second event is detected after the detection of the first event, the management module transmits the other of permission and prohibition of the execution of the specific process to the control module.

### CROSS REFERENCE TO RELATED APPLICATIONS

This application is a Continuation application of PCT Application No. PCT/JP2013/057925, filed Mar. 13, 2013 and based upon and claiming the benefit of priority from Japanese Patent Application No. 2012-163030, filed Jul. 23, 2012, the entire contents of all of which are incorporated herein by reference.

### FIELD

Embodiments described herein relate generally to an information process apparatus and a control method for restricting executable processes.

### BACKGROUND

In recent years, in companies, attention has been paid to bringing a personally owned information terminal or the like in a company and using it for business work (so-called Bring Your Own Device (BYOD)). As the information terminal, use can be made of various information processing apparatuses such as a tablet terminal or a smartphone.

In order to realize BYOD, it is necessary to apply various security measures to the information processing apparatus.

As one of security techniques, there is known a technique of determining whether a terminal exists in a specific area, and restricting the use of the terminal when the terminal exists in the specific area.

In the meantime, the kind of function (process), the use of which is to be permitted, and the kind of function (process), the use of which is to be prohibited, varies from company to company. Therefore, when an information processing apparatus is used in business work, it is necessary to realize a function for flexibly controlling the use of individual functions (processes).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a configuration of an information processing apparatus according to an embodiment.

FIG. 2 is an exemplary view illustrating a structure of an application package file which is used in the information processing apparatus of the embodiment.

FIG. 3 is an exemplary block diagram illustrating a configuration of an access detection/control module with a network connection restriction function, which is provided in the information processing apparatus of the embodiment.

FIG. 4 is an exemplary block diagram illustrating another configuration of the access detection/control module, which is provided in the information processing apparatus of the embodiment.

FIG. 5 is an exemplary block diagram illustrating still another configuration of the access detection/control module, which is provided in the information processing apparatus of the embodiment.

FIG. 6 is an exemplary block diagram illustrating a configuration of a communication connection management module in the access detection/control module, which is provided in the information processing apparatus of the embodiment.

FIG. 7 is an exemplary block diagram illustrating a configuration of a management application module, which is provided in the information processing apparatus of the embodiment.

FIG. 8 is an exemplary block diagram illustrating a configuration of a determination application module, which is provided in the information processing apparatus of the embodiment.

FIG. 9 is a view illustrating an example of rules which are stored in the determination application module of FIG. 8.

FIG. 10 is an exemplary flowchart illustrating the procedure of a process which is executed by an access detection/control module, management application module and determination application module, which are provided in the information processing apparatus of the embodiment.

FIG. 11 is an exemplary block diagram illustrating a configuration of the management application module including a determination application registration module, which is provided in the information processing apparatus of the embodiment.

FIG. 12 is an exemplary block diagram illustrating a configuration of the access detection/control module including a default determination rule management module, which is provided in the information processing apparatus of the embodiment.

FIG. 13 is an exemplary block diagram illustrating a configuration of the management application module including a default determination rule management module, which is provided in the information processing apparatus of the embodiment.

FIG. 14 is an exemplary flowchart illustrating the procedure of an applied rule selection process which is executed by the access detection/control module, management application module and determination application module, which are provided in the information processing apparatus of the embodiment.

FIG. 15 is an exemplary block diagram illustrating still another configuration of the management application module, which is provided in the information processing apparatus of the embodiment.

FIG. 16 is an exemplary block diagram illustrating still another configuration of the determination application module, which is provided in the information processing apparatus of the embodiment.

FIG. 17 is an exemplary block diagram illustrating still another configuration of the access detection/control module, which is provided in the information processing apparatus of the embodiment.

FIG. 18 is an exemplary flowchart illustrating a part of another procedure of the process which is executed by the installer module, access detection/control module, management application module and determination application module, which are provided in the information processing apparatus of the embodiment.

FIG. 19 is an exemplary flowchart illustrating a portion of the other part of the another procedure of the process which is executed by the installer module, access detection/control module, management application module and determination application module, which are provided in the information processing apparatus of the embodiment.

FIG. 20 is an exemplary flowchart illustrating the other portion of the other part of the another procedure of the process which is executed by the installer module, access detection/control module, management application module and determination application module, which are provided in the information processing apparatus of the embodiment.

FIG. 21 is an exemplary block diagram illustrating a configuration of the determination application module including an action setup module, which is provided in the information processing apparatus of the embodiment.

FIG. 22 is a view illustrating a part of rules which are stored in the determination application module of FIG. 21.

FIG. 23 is an exemplary block diagram illustrating a configuration of the management application module including an action reception module and an event determination module, which is provided in the information processing apparatus of the embodiment.

FIG. 24 is an exemplary flowchart illustrating the procedure of a process corresponding to a case where an action is executed by the access detection/control module, which is provided in the information processing apparatus of the embodiment.

FIG. 25 is an exemplary flowchart illustrating another procedure of the process corresponding to the case where an action is executed by the access detection/control module, which is provided in the information processing apparatus of the embodiment.

FIG. 26 is an exemplary flowchart illustrating another procedure of the process corresponding to the case where an action is executed by the access detection/control module, which is provided in the information processing apparatus of the embodiment.

FIG. 27 is an exemplary block diagram illustrating another configuration of the information processing apparatus of the embodiment.

FIG. 28 is an exemplary block diagram illustrating another configuration of the communication connection management module provided in the access detection/control module of the information processing apparatus of the embodiment.

FIG. 29 is an exemplary view for describing a rule change process which is executed by the determination application module provided in the information processing apparatus of the embodiment.

FIG. 30 is a view illustrating another example of rules which are stored in the determination application module provided in the information processing apparatus of the embodiment.

FIG. 31 is a block diagram illustrating a hardware configuration example of the information processing apparatus of the embodiment.

### DETAILED DESCRIPTION

Various embodiments will be described hereinafter with reference to the accompanying drawings.

In general, according to one embodiment, an information processing apparatus comprises a management module and a control module. The management module is configured to provide an environment for restricting executable processes of the information processing apparatus. The control module is configured to detect each of a plurality of events comprising an event of requesting a connection to any one of a plurality of external communication devices and an event of requesting execution of a process other than a request for connection to an external communication device, and to transmit, prior to execution of a process corresponding to a detected event, a content of the detected event to the management module.

The management module is configured to notify the content of the detected event to a determination program, to receive from the determination program a determination result indicative of permission or prohibition of the detected event, and to transmit the determination result to the control module. The management module is further configured to (i) transmit, when the detected event is a first event of requesting a connection to a specific external communication device, a determination result indicative of permission of the connection to the specific external communication device to the control module, to (ii) transmit, when the detected event is a second event of requesting execution of a specific process and the connection to the specific external communication device is not permitted, a first determination result indicative of one of permission and prohibition of the execution of the specific process to the control module, and to (iii) transmit, when the detected event is the second event and the connection to the specific external communication device is permitted, a second determination result indicative of the other of permission and prohibition of the execution of the specific process to the control module.

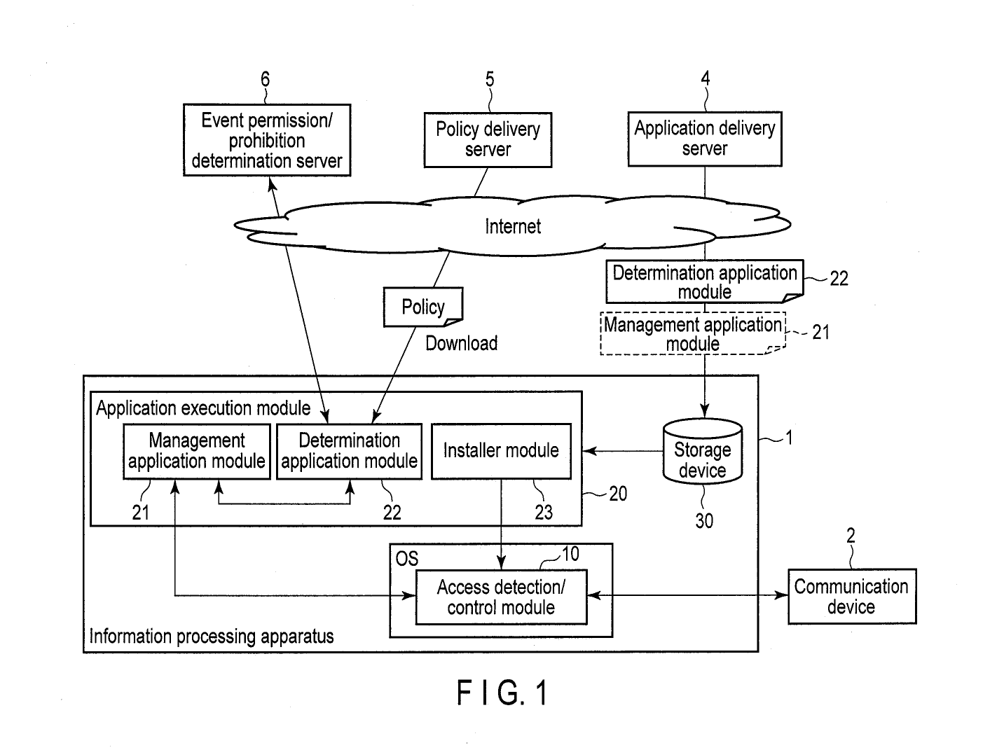

FIG. 1 shows the structure of an information processing apparatus 1 according to an embodiment. This information processing apparatus 1 is configured to execute various application programs, and may be realized by, for example, a tablet terminal, a smartphone, a PDA, or other various information terminals. The information processing apparatus 1 is configured to execute wireless communication according to some wireless communication standards, for instance, WiFi®, third-generation mobile communication (3G), Bluetooth®, etc. Using the wireless communication function, the information processing apparatus 1 can communicate with an external communication device 2 such as a wireless access point, and various servers on the Internet. In addition, the information processing apparatus 1 has a function of accessing an external storage device 2 such as a USB memory or an SD memory card.

The information processing apparatus 1 includes a process restriction function for executing various process restrictions, such as a restriction of connection between the information processing apparatus 1 and various external communication devices, a restriction of connection between the information processing apparatus 1 and various external storage devices, a restriction of install of some specific application programs, and a restriction of launch (start) of some specific application programs. In order to realize the process restriction function, the information processing apparatus 1 includes three different modules, namely an access detection/control module 10, a management application module 21 and a determination application module 22.

The access detection/control module 10 can be realized by a software module in an operating system (OS) layer. This software module may be, for example, middleware in the OS layer, or a kernel in the OS layer such as a Linux® kernel. Each of the management application module 21 and determination application module 22 can be realized by an application program which is executed on an application execution module 20. This application program may be, for example, an Android® application program.

The application execution module 20 is a platform for executing various application programs, and can be realized by, for example, a virtual machine such as a Java® virtual machine.

The information processing apparatus 1 can download various application programs (various application package files) from an application delivery server 4 via the Internet. Each application program, which is downloaded, is stored in a storage module (storage device) 30 in the information processing apparatus 1. The determination application module 22 is also downloaded from the application delivery server 4 and stored in the storage module 30. The management application module 21 can also be downloaded from the application delivery server 4. Incidentally, the management application module 21 and the installer module 23 may be pre-installed in the information processing apparatus 1. In this case, it is not always necessary to download the management application module 21.

The installer module 23 executes a process of expanding the application package file of each application program (management application module 21, determination application module 22 and other various applications) which has been downloaded in the storage module 30 from the application delivery server 4, and installing each application program in the storage module 30.

The application execution module 20 loads each application program (management application module 21, determination application module 22, and other various applications) from the storage module 30 and executes each application program.

The access detection/control module 10 detects an event of requesting a connection to any one of various external communication devices, notifies, prior to the execution of a process corresponding to the detected event, that is, prior to execution of the requested connection process, the content of the detected event to the management application module 21, and controls the permission/prohibition of the connection process, based on an instruction from the management application module 21.

Examples of the request for connection to the external communication device include a connection request to a WiFi® access point, and a connection request to a Bluetooth® device.

For example, if the access detection/control module 10 detects an event of requesting a connection to a WiFi® access point having a specific name or a specific address, the access detection/control module 10 suspends a connection process of connecting the information processing apparatus 1 and the WiFi® access point, and transmits event information indicative of the content of this event to the management application module 21. Then, based on a determination result indicative of permission or prohibition of connection, which is returned from the management application module 21, the access detection/control module 10 executes the connection process or cancels (prohibits) the execution of the connection process.

Besides, the access detection/control module 10 can detect, as well as the event (network connection event) of requesting a connection to the external communication device, other various events of requesting execution of various processes other than the connection to the external communication device. For example, the access detection/control module 10 detects an SD card connection request, a USB memory connection request, a request for starting (launching) an application program, a request for install of an application program, and a request for uninstall of an application program.

Also when an event, other than the event of requesting a connection to the external communication device, has been detected, the access detection/control module 10 can transmit, prior to the execution of this event, event information indicative of the detected event to the management application module 21, and can control permission/prohibition of the execution of the event, based on an instruction from the management application module 21.

For example, if the access detection/control module 10 detects an event (install event) of requesting install of a certain application program, the access detection/control module 10 suspends a process of installing the application program, and transmits event information (install event information) including the application name of this application program to the management application module 21. Then, based on a determination result indicative of permission or prohibition of install, which is returned from the management application module 21, the access detection/control module 10 executes the install process or cancels (prohibits) the execution of the install process.

In addition, if the access detection/control module 10 detects an event (application start event) of requesting launch of a certain application program, the access detection/control module 10 suspends a process of starting (launching) the application program, and transmits start event information including the application name of this application program to the management application module 21. Then, based on a determination result indicative of permission or prohibition of launch of the application which is returned from the management application module 21, the access detection/control module 10 executes the start process for launching the application program or cancels (prohibits) the execution of the start process.

The management application module 21 functions as a management module configured to provide an environment for restricting executable processes of the information processing apparatus 1, that is, processes which the information processing apparatus 1 is permitted to execute. When the management application module 21 is started, the management application module 21 can request the access detection/control module 10 to notify the management application module 21 of the above-described various events. Further, if the management application module 21 receives event information from the access detection/control module 10, the management application module 21 notifies the determination application module 22 of the content of the received event information, and transmits a determination result, which is received from the determination application module 22, to the access detection/control module 10.

The determination application module 22 has a predetermined policy (determination rule). Based on the policy, the determination application module 22 determines permission or prohibition of a process corresponding to each event which is received from the management application module 21, and notifies the determination result to the management application module 21. Incidentally, the determination application module 22 can download, where necessary, a policy (determination rule) from a policy delivery server 5. By downloading the policy (determination rule) from the policy delivery server 5, the determination application module 22 can easily update the policy, for example, at regular intervals. In addition, a policy may be embedded in advance in the determination application module 22. In this case, the policy can be updated by upgrading the version of the determination application module 22 itself which is to be executed by the application execution module 20. Furthermore, the determination application module 22 can inquire of an event permission/prohibition determination server 6 about permission/prohibition of execution of an event.

When the determination result notified by the management application module 21 is indicative of, e.g. prohibition of connection, the access detection/control module 10 prohibits a process of establishing the requested connection. For example, the access detection/control module 10 prohibits a process of establishing a connection to a network (external communication device), or a process of establishing a connection to an external storage device such as an SD memory card or a USB memory. Thereby, a connection to a WiFi® access point, the connection to which is not permitted, a connection to a Bluetooth® device, the connection to which is not permitted, or a connection to an external storage device, the use of which is not permitted, can be prevented.

On the other hand, when the determination result notified by the management application module 21 is indicative of permission of connection, the access detection/control module 10 executes the requested connection process.

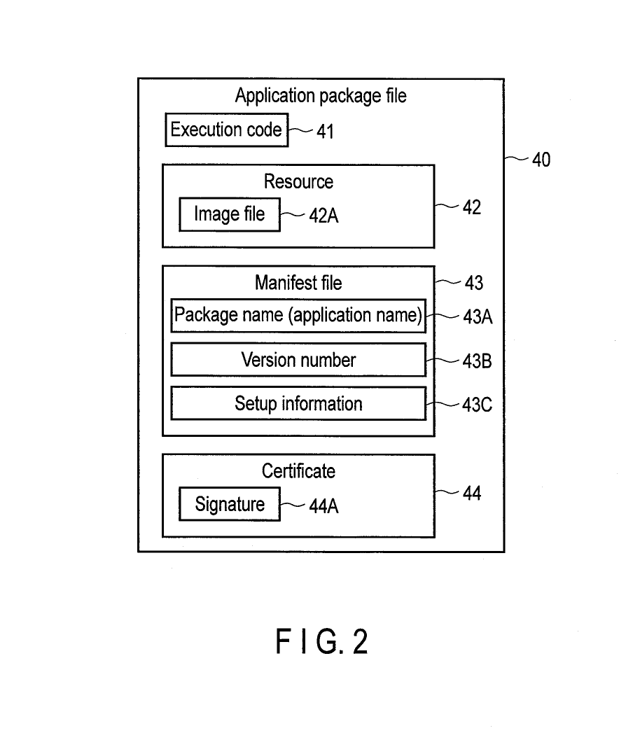

FIG. 2 shows a structure of an application package file 40 which is used in the information processing apparatus 1. As shown in FIG. 2, an application name (package name) and a certificate including a signature are given to each application package file 40.

To be more specific, each application package file 40 includes an execution code 41, a resource 42, a manifest file 43 and a certificate 44. The resource 42 includes an image file 42A such as a thumbnail image file which is used as an icon. The manifest file 43 includes a package name (application name) 43A, a version number 43B and setup information 43C.

The certificate 44 is information for confirming the developer of the application package file 40 and for certifying that the application package file 40 is not illegitimately modified, and the certificate 44 includes an electronic signature (signature 44A). The signature 44A is calculated by, for example, public key encryption using a secret key possessed by the developer of the application program, and a message. As a public key encryption algorithm that is used for signature calculation, use may be made of a well-known public key algorithm such as RSA or EC-DSA. This message may be a digest value of each file (execution code 41, resource 42, manifest file 43) included in the application package file 40.

The secret key that is used for the signature varies from application developer to application developer. In the present embodiment, it is assumed that the secret key that is used for the signature of the management application module 21 is different from the secret key that is used for the signature of the determination application module 22. Specifically, it is assumed that the management application module 21 and determination application module 22 were developed by different application developer.

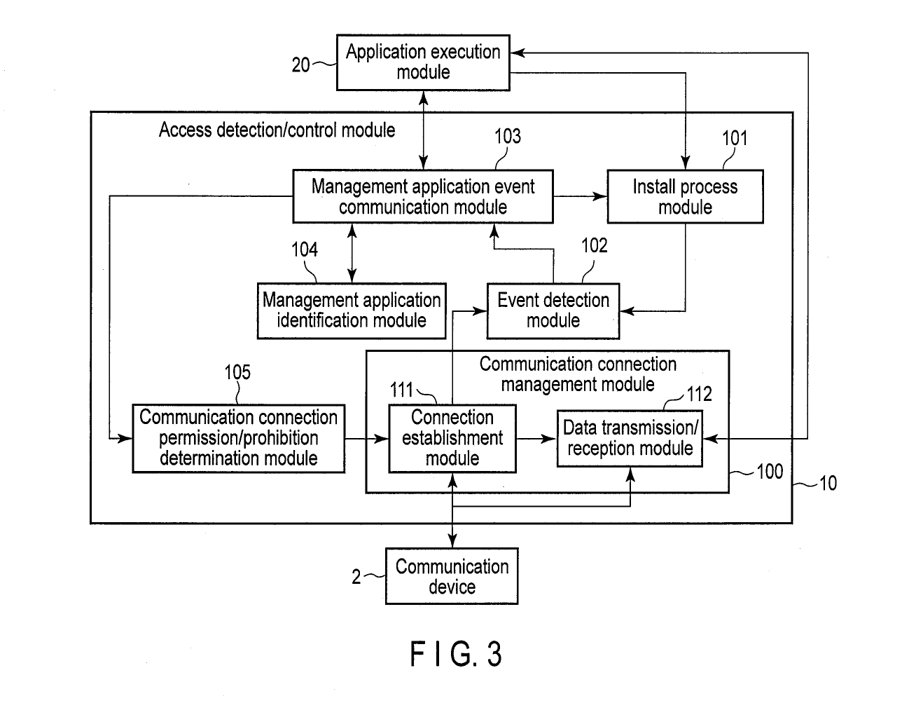

FIG. 3 shows a configuration of the above-described access detection/control module 10. The case is assumed that the access detection/control module 10 includes a network (external communication device) connection restriction function and an install restriction function.

As shown in FIG. 3, the access detection/control module 10 includes a communication connection management module 100, an install process module 101, an event detection module 102, a management application event communication module 103, a management application identification module 104 and a communication connection permission/prohibition determination module 105.

The communication connection management module 100 controls connection between the information processing apparatus 1 and the external communication device 2 such as a WiFi® access point or a Bluetooth® device. The communication connection management module 100 includes a connection establishment module 111 and a data transmission/reception module 112. The connection establishment module 111 detects the occurrence of a connection request when the connection establishment module 111 has received a connection establishment request from the external communication device 2, or when a request has occurred for transmitting a connection establishment request to the external communication device 2, and notifies the occurrence of the connection request to the event detection module 102. The occurrence of the connection request for connection to the external communication device 2 is detected as a network connection event by the event detection module 102.

The management application event communication module 103 notifies event information indicative of the content of the network connection event to the above-described management application module 21 in the application execution module 20. The management application identification module 104 identifies which of applications on the application execution module 20 is the management application module 21. After detected by the event detection module 102, the event information (network connection event information) is transmitted, via the management application event communication module 103, to the application which has been identified as the management application module 21 by the management application identification module 104. Specifically, the management application identification module 104 prestores the application name of the management application module 21. Then, upon receiving a registration request from the application, the management application identification module 104 determines, based on the prestored application name, whether this application is the management application module 21 (the application program having the prestored application name), that is, whether this application is a communication counterpart to which the network connection event information is to be transmitted. If it has been determined that the application is the communication counterpart to which the network connection event information is to be transmitted, this application is identified as the management application module 21. Except for update of the application, the installation in the system of two applications having the same application name is restricted by the installer module 23. Therefore, by prestoring the application name of the management application module 21 in the management application identification module 104, the management application module 21 can uniquely be identified.

The management application event communication module 103 executes communication with the application program which has been identified by the management application identification module 104. Thereby, the event information can be prevented from being intercepted by a malicious application program.

Upon receiving a determination result from the management application module 21 in the application execution module 20, the management application event communication module 103 outputs the received determination result to the communication connection permission/prohibition determination module 105. The communication connection permission/prohibition module 105 notifies, based on the content of the determination result, the permission/prohibition of connection establishment to the connection establishment module 111 of the communication connection management module 100. If the determination result is indicative of permission of network connection, the connection establishment module 111 executes a connection establishment process and establishes a connection to the external communication device 2. On the other hand, if the determination result is indicative of prohibition of network connection, the connection establishment module 111 cancels (prohibits) the connection establishment process.

Upon receiving an instruction for starting install (an install request) from the installer in the application execution module 20, the install process module 101 causes the installer in the application execution module 101 to wait for the execution of the process of install. The occurrence of the install request is detected as an install event by the event detection module 102. The management application event communication module 103 notifies the event information (install event information) including the install event and the application name of the install target to the management application module 21 in the application execution module 20. Upon receiving a determination result from the management application module 21, the management application event communication module 103 notifies the received determination result (permission/prohibition of install) to the install process module 101.

If the determination result is indicative of permission of install, the install process module 101, in cooperation with the installer module 23, executes the install process. On the other hand, if the determination result is indicative of prohibition of install, the install process module 101 cancels (prohibits) the install process.

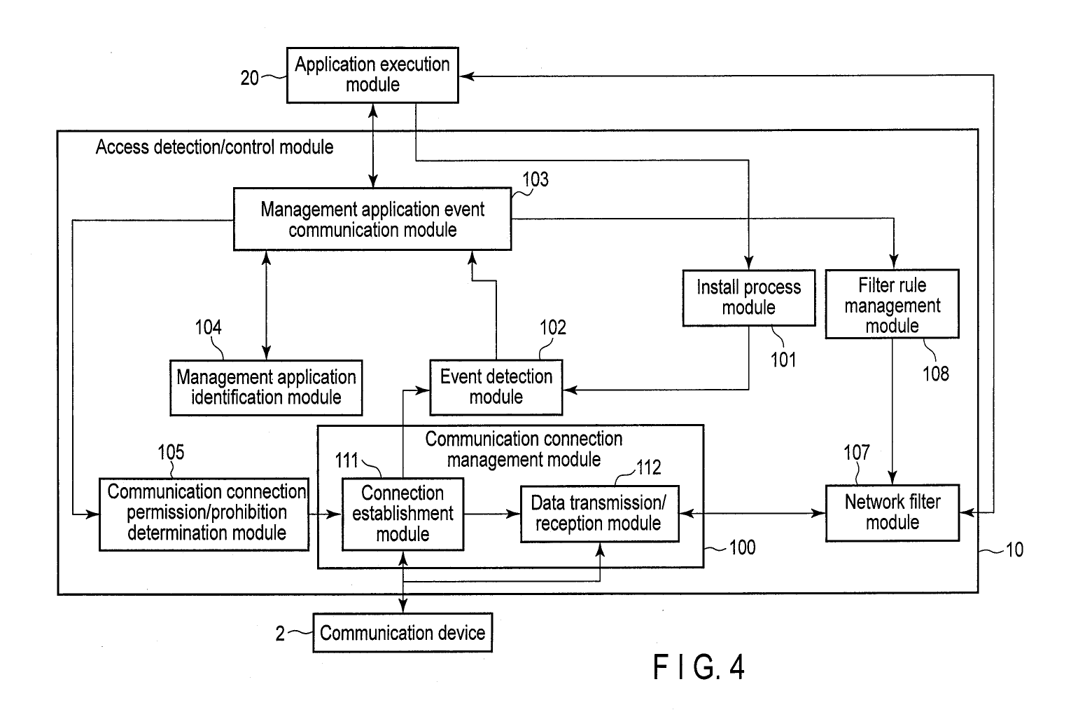

FIG. 4 shows another configuration of the access detection/control module 10. The difference from the configuration of FIG. 3 is that access detection/control module 10 includes a network filter module 107 and a filter rule management module 108.

The network filter module 107 is a process module configured to restrict, according to rules set in the filter rule management module 108, the IP address of a communication counterpart or the port number (TCP port number or UDP port number) of the communication counterpart, when an application of the application execution module 20 communicates with a device, such as a server, by the Internet protocol after a WiFi® connection or a Bluetooth® connection was established by the communication connection management module 100.

The filter rule management module 108 stores rules of a communication-destination IP address and a communication-destination port number, the use of which is to be permitted, or rules of a communication-destination IP address and a communication-destination port number, the use of which is to be prohibited. The filter rule management module 108 may include default rules at a time of initial setup. In this case, the filter rules in the filter rule management module 108 may be updated via the management application event communication module 103 by an instruction of the management application module 21.

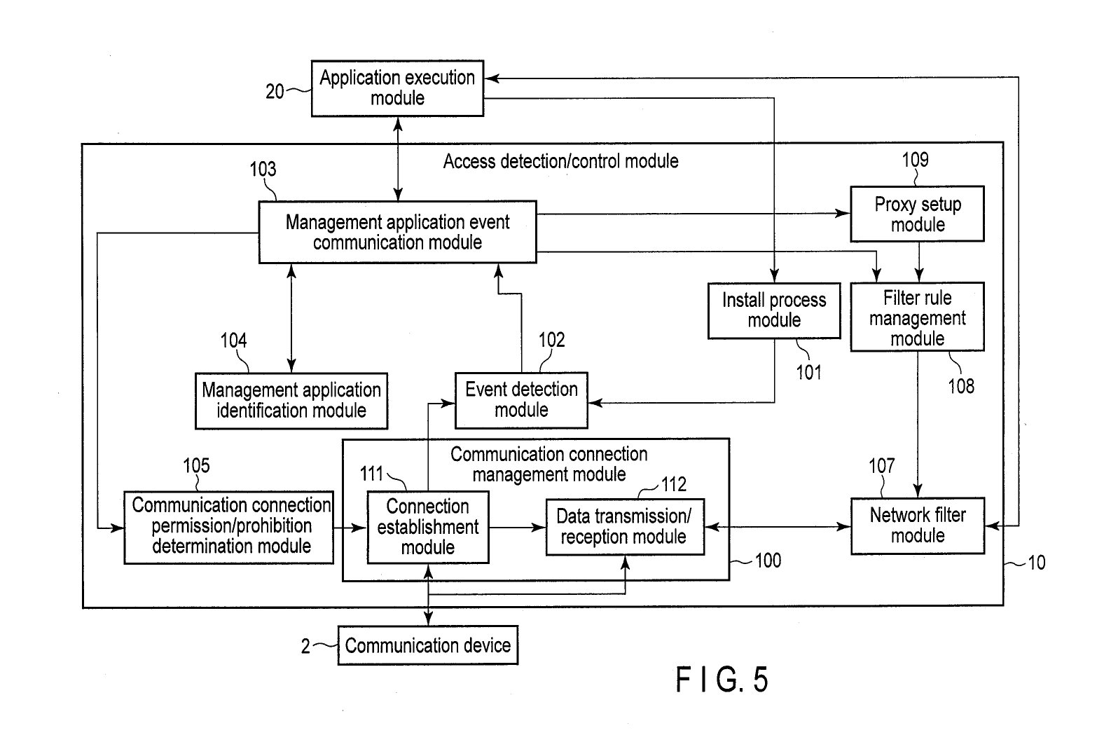

FIG. 5 shows another configuration of the access detection/control module 10. The difference from the configuration of FIG. 4 is that the access detection/control module 10 includes a proxy setup module 109.

The proxy setup module 109 is a process module configured to set up a proxy server such as an HTTP proxy, an SSL proxy or an FTP proxy. When each application of the application execution module 20 executes network communication and communicates with a communication device such as a server or the like, each application communicates with a proxy server which was set up by the proxy setup module 109. When no proxy is set up by the proxy setup module 109, each application communicates directly with the communication device.

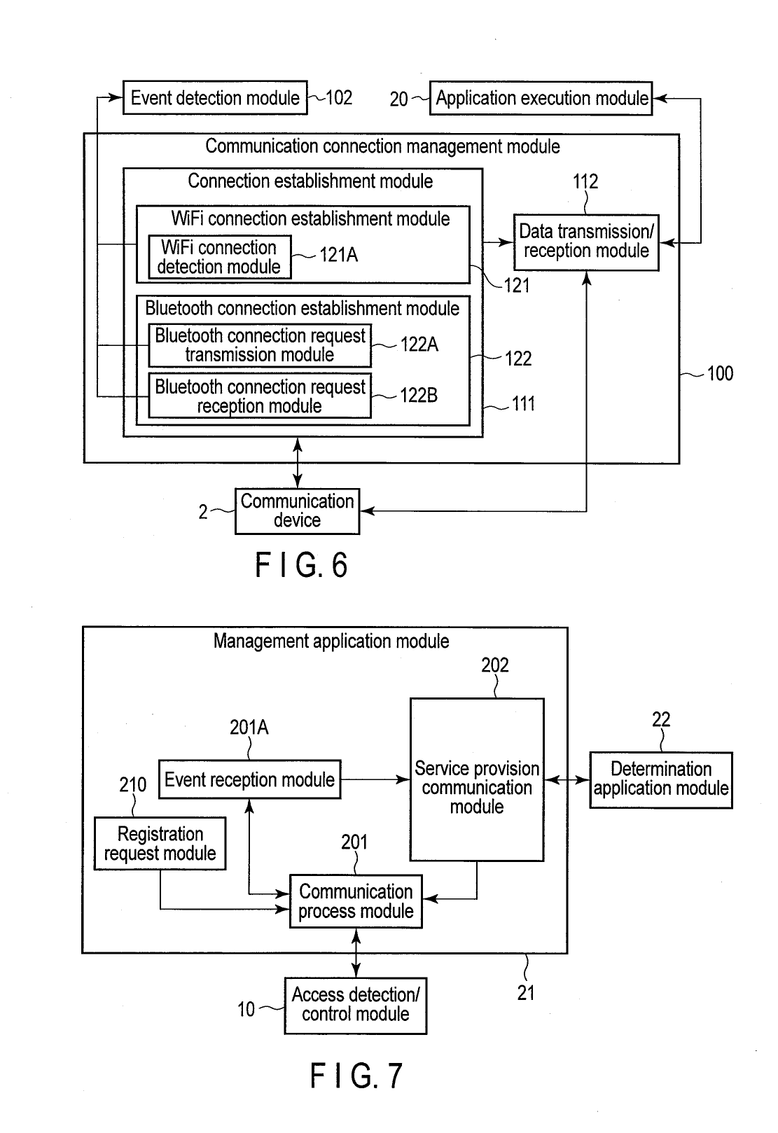

FIG. 6 illustrates a configuration of the communication connection management module 100 which is provided in the access detection/control module 10. The kinds of the network connection event, which is transmitted from the communication connection management module 100 to the event detection module 102, are, for example, the following three:

(1) WiFi® connection detection,

(2) Bluetooth® connection request transmission (Bluetooth® client function), and

(3) Bluetooth® connection request reception (Bluetooth® server function).

The connection establishment module 111 of the communication connection management module 100 includes a WiFi® connection establishment module 121 and a Bluetooth® connection establishment module 122. The WiFi® connection establishment module 121 includes a WiFi® connection detection module 121A. The WiFi® connection detection module 121A detects a nearby WiFi® access point, and notifies the event detection module 102 of a connection request including the name and address of the detected WiFi® access point. The Bluetooth® connection establishment module 122 includes a Bluetooth® connection request transmission module 122A and a Bluetooth® connection request reception module 122B. The Bluetooth® connection request transmission module 122A executes a process of transmitting a connection establishment request signal to an external Bluetooth® device. When a request has occurred for transmitting a connection establishment request signal to an external Bluetooth® device, the Bluetooth® connection request transmission module 122A notifies the event detection module 102 of a connection request including the address, etc. of this external Bluetooth® device. The Bluetooth® connection request reception module 122B is configured to receive a connection establishment request signal from an external Bluetooth® device. When the Bluetooth® connection request reception module 122B has received a connection establishment request signal from an external Bluetooth® device, the Bluetooth® connection request reception module 122B notifies the event detection module 102 of a connection request including the address, etc. of this external Bluetooth® device.

FIG. 7 shows a configuration of the management application module 21. The management application module 21 includes a communication process module 201, a service provision communication module 202, an event reception module 201A and a registration request module 210.

The communication process module 201 communicates with the access detection/control module 10. The event reception module 201A receives various events (network connection event, external storage connection event, install event, application launch event, etc.) from the access detection/control module 10 via the communication process module 201. The content of the received event is notified to the service provision communication module 202 as event information. The service provision communication module 202 notifies the content of the event to the determination application module 22, and receives from the determination application module 22 a determination result indicative of permission or prohibition of execution of this event. The determination result is transmitted to the access detection/control module 10 via the communication process module 201.

The registration request module 210 is a process module which transmits, when the management application module 21 is started, a request to the access detection/control module 10 via the communication process module 201, the request asking the access detection/control module 10 to transmit events, which will subsequently be detected by the access detection/control module 10, to the management application module 21.

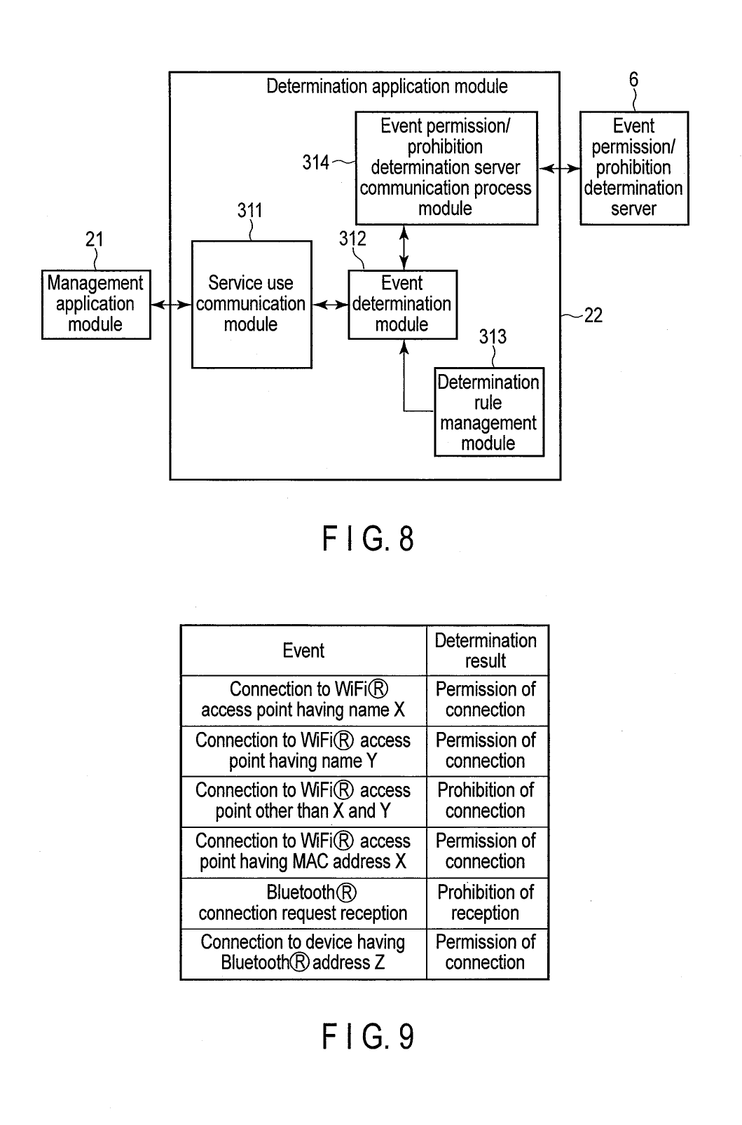

FIG. 8 shows a configuration of the determination application module 22. As shown in FIG. 8, the determination application module 22 includes a service use communication module 311, an event determination module 312, a determination rule management module 313 and an event permission/prohibition determination server communication process module 314.

The service use communication module 311 communicates with the management application module 21. Based on a rule set (determination rules) which is present in the determination rule management module 313, the event determination module 312 determines permission or prohibition of a process corresponding to the received event. The rule set (determination rules) may be, for example, a list (white list) of names or addresses of external communication devices, the connection to which is to be permitted, or a list (black list) of names or addresses of external communication devices, the connection to which is to be prohibited. In addition, the rule set may store IP addresses, the connection to which is to be prohibited. Besides, the rule set may store a list of application names the install of which is to be permitted (or a list of application names the install of which is to be prohibited), a list of application names the launch of which is to be permitted (or a list of application names the launch of which is to be prohibited), and a list of application names the uninstall of which is to be permitted (or a list of application names the uninstall of which is to be prohibited).

The event permission/prohibition determination server communication process module 314 inquires of the event permission/prohibition determination server 6 about permission/prohibition of execution of each event, and receives permission/prohibition of execution of each event from the event permission/prohibition determination server 6. The event determination module 312 can determine, where necessary, permission/prohibition of execution of the event by using the event permission/prohibition determination server communication process module 314.

In the meantime, it is not always necessary that both the determination rule management module 313 and the event permission/prohibition determination server communication process module 314 be provided in the determination application module 22. Such a configuration may be adopted that only either the determination rule management module 313 or the event permission/prohibition determination server communication process module 314 is provided in the determination application module 22.

In addition, the event determination module 312 can also execute determination of permission or prohibition of an external storage event of requesting a connection to an external storage device, based on the rule set existing in the determination rule management module 313, or by using the event permission/prohibition determination server 6.

FIG. 9 shows an example of a rule set (determination rules) which is stored in the determination application module 22 of FIG. 8. FIG. 9 illustrates, by way of example, only a rule set relating to network connection events. As shown in FIG. 9, in the determination application module 22, for each of contents of events relating to network connection events, a determination result indicative of permission or prohibition of each event is stored as the above-described rule set. The respective event contents can be classified as follows:

(1) WiFi® connection,

(2) a combination of WiFi® connection and an access point name,

(3) a combination of WiFi® connection and an address (MAC (Media Access Control) address),

(4) a combination of WiFi® connection, an access point name and an address (MAC address),

(5) Bluetooth® connection,

(6) Bluetooth® connection request reception,

(7) a combination of Bluetooth® connection request reception, and an address of a Bluetooth® device at a source of transmission of a Bluetooth® connection request,

(8) Bluetooth® connection request transmission, and

(9) a combination of Bluetooth® connection request transmission, and an address of a Bluetooth® device at a destination of transmission of a Bluetooth® connection request.

An arbitrary combination of (1) to (9) may be used as an event.

In FIG. 9, the case is assumed that a connection to a WiFi® access point having an access point name “X” or “Y” is permitted, and a connection to a WiFi® access point having an access point name other than “X” or “Y” is prohibited. Further, a connection to a WiFi® access point having a MAC address “X” is permitted. When a connection request has been received from an external Bluetooth® device, the connection is prohibited (Bluetooth® connection request reception=prohibition of reception). A process for connecting between the information processing apparatus 1 operating as an initiator and an external Bluetooth® device having an address “Z” is permitted.

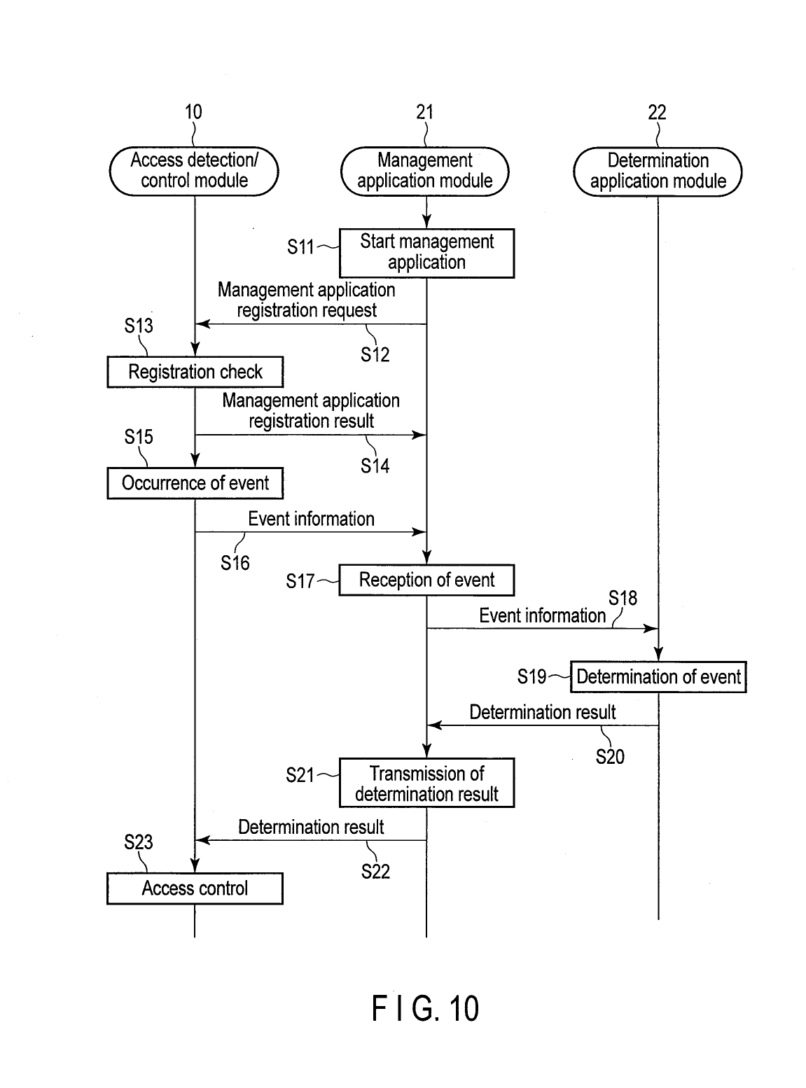

Next, referring to a flowchart of FIG. 10, a description is given of the procedure of a process which is executed by the access detection/control module 10, management application module 21 and determination application module 22.

If the management application module 21 is started (step S11), the registration request module 210 of the management application module 21 requests the access detection/control module 10 to register the management application module 21 (step S12). Upon receiving the registration request from the application, the access detection/control module 10 examines the name of the application which has transmitted the registration request, and checks, based on the prestored application name, whether the application which has transmitted the registration request is the management application module 21 (the application program having the prestored application name). If it is confirmed that the application is the management application module 21, the access detection/control module 10 registers the application, which has transmitted the registration request, as the management application module 21 (step S13). Then, the access detection/control module 10 notifies the management application module 21, that is, the application which has transmitted the registration request, of the success in registration of the management application module 21 (step S14).

If an event, such as a network connection event, occurs (step S15), the access detection/control module 10 transmits event information indicative of the content of the event to the management application module 21, prior to executing the event (step S16).

The management application module 21 receives the event information from the access detection/control module 10 (step S17), and notifies the received event information to the determination application module 22 (step S18). Based on the above-described rule set, the determination application module 22 determines permission or prohibition of the event designated by the event information, for instance, a network connection process (step S19). Then, the determination application module 22 transmits a determination result indicative of permission or prohibition of this event to the management application module 21 (step S20).

The management application module 21 receives the determination result from the above-described determination application module 22, and transmits the received determination result to the access detection/control module 10 (step S21, S22). Based on the determination result, the access detection/control module 10 controls the execution of the process corresponding to the event which has occurred (step S23). In step S23, if the determination result is indicative of permission, the access detection/control module 10 executes the process requested by the event, for example, the network connection process. On the other hand, if the determination result is indicative of prohibition, the access detection/control module 10 cancels (prohibits) the process requested by the event, for example, the network connection process.

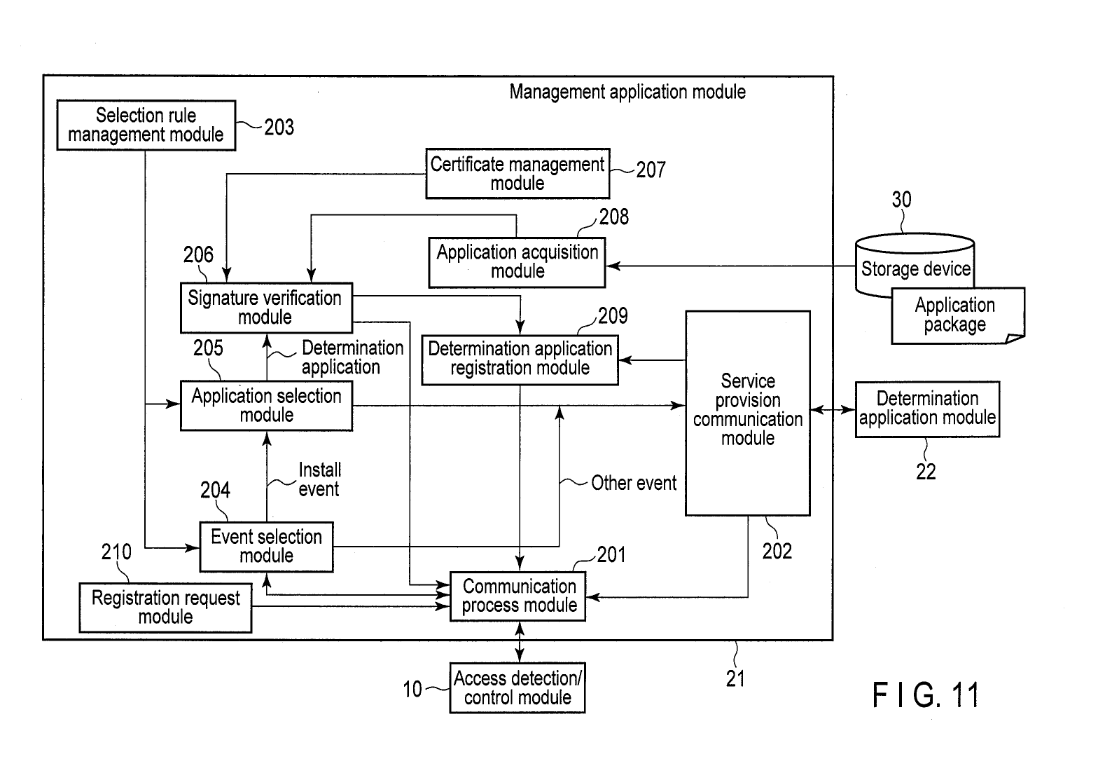

FIG. 11 shows another configuration of the management application module 21. When the determination application module 22 (determination program) is to be installed, the management application module 21 confirms the integrity of the determination application module 22, based on a certificate (signature) which is given to the determination application module 22. When the integrity of the determination application module 22 has been confirmed, the management application module 21 identifies the determination application module 22 as the communication counterpart to which event information is to be notified.

The management application module 21 includes a communication process module 201, a service provision communication module 202, a selection rule management module 203, an event selection module 204, an application selection module 205, a signature verification module 206, a certificate management module 207, an application acquisition module 208, and a determination application registration module 209.

The communication process module 201 communicates with the access detection/control module 10. The communication process module 201 receives various events which are notified from the access detection/control module 10 (a network connection event, an external storage connection event, an install event, an application launch event, an uninstall event, etc.).

The service provision communication module 202 notifies the content of an event to the determination application module 22 which is registered in the determination application registration module 209, that is, the determination application module 22 which has been confirmed to be the authenticated determination application, and receives from the determination application module 22 a determination result indicative of permission or prohibition of execution of the event.

The selection rule management module 203 stores a selection rule for classifying various events, which are notified from the access detection/control module 10, into kinds of events. In the selection rule, for example, event names corresponding to a network connection event, an external storage connection event, an install event, an application launch event and an uninstall event, and at least one application name (determination application name), which is usable as the determination application, are stored.

The event selection module 204 determines whether the event, which has been received from the access detection/control module 10, is the network connection event, external storage connection event, install event, application launch event or uninstall event. If the received event is an install event, the event selection module 204 transmits to the application selection module 205 the content of the received event, that is, the install event and the application name associated with this install event. If the received event is an event other than the install event, the event selection module 204 transmits the content of the received event to the service provision communication module 202.

The application selection module 205 determines whether the application name, which has been received from the event selection module 204, is the determination application name which is stored in the selection rule management module 203, thereby determining whether the install-target application is the determination application. If the install-target application is the determination application, the application selection module 205 transmits the application name of this determination application to the signature verification module 206, and notifies the signature verification module 206 that the install-target application is the determination application. On the other hand, if the install-target application is an application other than the determination application, the application selection module 205 transmits to the service provision communication module 202 the install event information including the application name of the install-target application.

If the install-target application is the determination application module 22, the signature verification module 206 executes signature verification for the determination application module 22, and determines whether the install-target determination application module 22 is an authenticated determination application. In the signature verification, the signature verification module 206 instructs the application acquisition module 208 to acquire the application package file of the determination application which is stored in the storage module 30, and determines whether the determination application module 22 is an authenticated determination application, based on the certificate 40, etc. included in this application package file.

The certificate management module 207 stores, for example, public keys corresponding to respective developers. The above-described signature verification may be executed based on this public key, the signature 44A included in the certificate 40, and the files (execution code 41, resource 42, manifest file 43) included in the application package file 40. By this signature verification, it is verified whether the developer of the application package file of the determination application is correct or not, and whether the application package file is not illegitimately modified and is authenticated.

Only when the signature verification has successfully been executed, does the signature verification module 206 register the application name of the install-target determination application module 22 in the determination application registration module 209. The determination application registration module 209 transmits the determination result, which is indicative of permission of install of the determination application module 22 that is the install target, to the access detection/execution module 10 via the communication process module 201. Thereby, the install of the determination application module 22 is executed by the access detection/execution module 10. The service provision communication module 202 communicates with only the application which is registered in the determination application registration module 209. Specifically, only when the signature verification of the determination application module 22 has successfully been executed, will the management application module 21 transmit subsequent events to the determination application module 22.

When the signature verification has failed, the signature verification module 206 notifies the access detection/control module 10 via the communication process module 201 that the install is prohibited. Based on this instruction, the access detection/control module 10 prohibits the install of the determination application that is the install target. As a result, this application is not installed. Alternatively, the signature verification module 206 may notify the determination application registration module 209 that the signature verification has failed, and the determination application registration module 209, which has received this notification, may not register the application name and may transmit the determination result, which is indicative of permission of install of the determination application module 22 that is the install target, to the access detection/execution module 10 via the communication process module 201. In this case, the install of the application itself, which is the install target, is executed, but the management application module 21 does not register this application as the determination application module 22, and thus subsequent events will not be transmitted to this application.

The registration request module 210 is a process module which transmits, when the management application module 21 is started, a request to the access detection/control module 10 via the communication process module 201, the request asking the access detection/control module 10 to transmit events, which will subsequently be detected by the access detection/control module 10, to the management application module 21.

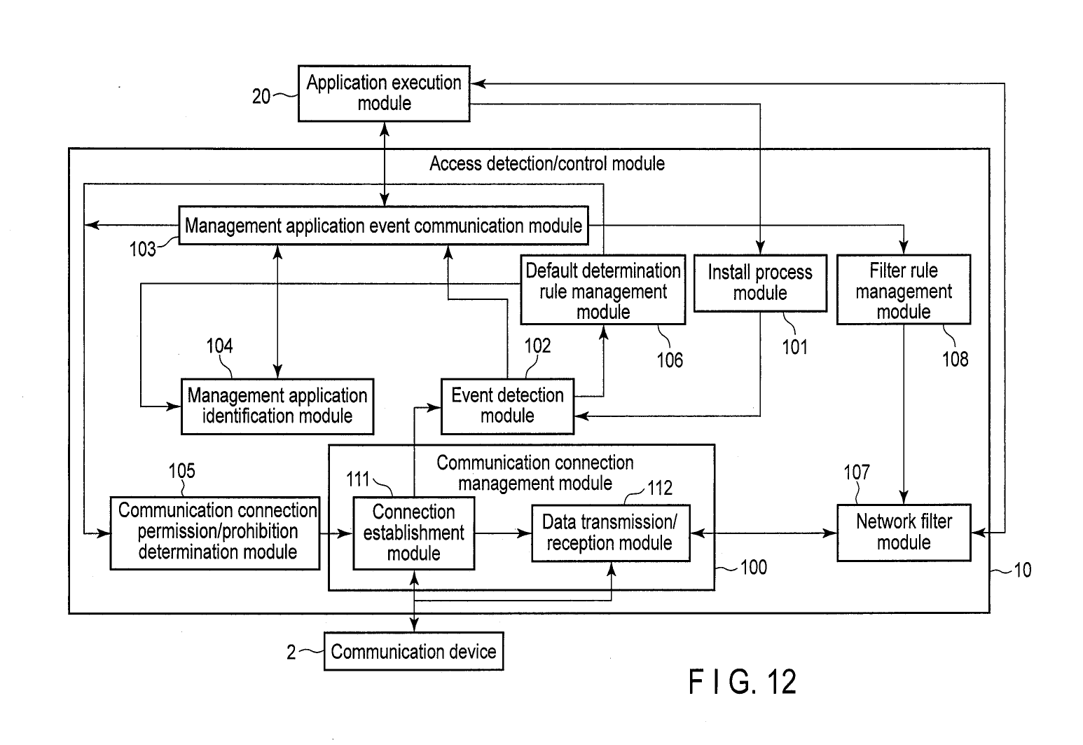

FIG. 12 illustrates a configuration of the access detection/control module 10 in which a default determination rule management module 106 is added.

The access detection/control module 10 includes a default policy (default determination rule) for determining permission or prohibition of each event. For example, when communication with the management application module 21 is not executable due to some cause, the access detection/control module 10 determines permission or prohibition of each event, according to a default determination rule which is stored in the default determination rule management module 106. Also in the case where the application name of the management application module 21 is not registered in the access detection/control module 10, communication with the management application module 21 is not executable, and thus the default determination rule is used.

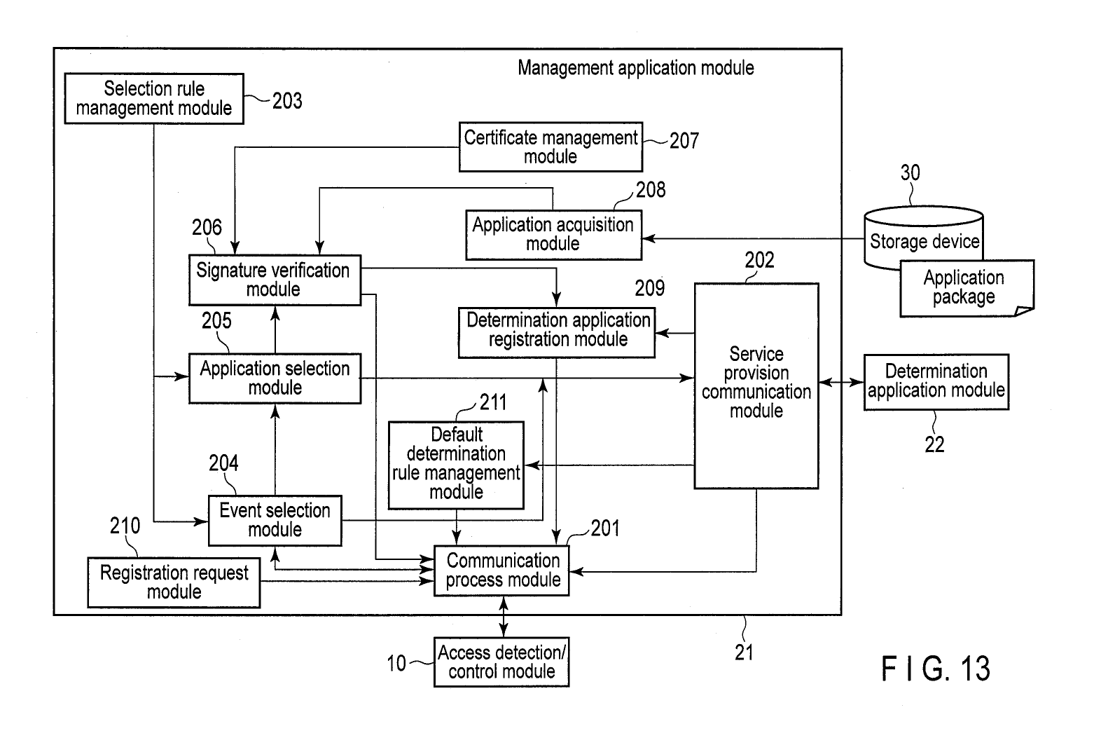

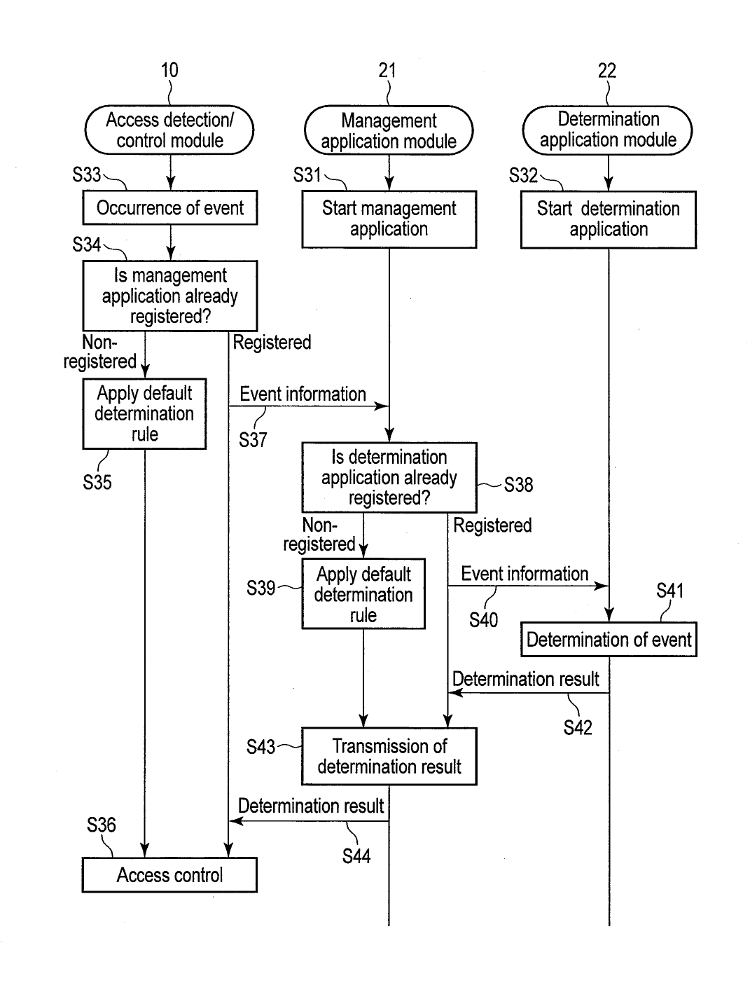

FIG. 13 illustrates a configuration of the management application module 21 in which a default determination rule management module 211 is added.

The management application module 21 may also include a default policy (default determination rule) for determining permission or prohibition of each event. In the case where communication with the determination application module 22, which is identified by the application name registered in the determination application registration module 209, is not executable due to some cause, or in the case where the determination application module 22 is not registered, the management application module 21 determines permission or prohibition of each received event, according to a default determination rule which is stored in the default determination rule management module 211. The determination result according to the default determination rule is transmitted to the access detection/control module 10 via the communication process module 201.

Next, referring to a flowchart of FIG. 14, a description is given of another example of the procedure of the process which is executed by the access detection/control module 10, management application module 21 and determination application module 22. It is assumed that both the management application module 21 and the determination application module 22 are started (step S31, S32).

If an event, such as a network connection event, occurs (step S33), the access detection/control module 10 determines whether the management application module 21 has already been registered (step S34).

If the management application module 21 has not been registered, the access detection/control module 10 determines permission or prohibition of a detected event, based on the default determination rule which is stored in the access detection/control module 10, and controls the execution of the process corresponding to the detected event, based on the determination result (step S36). In step S36, if the determination result is indicative of permission of the event, the access detection/control module 10 executes the process requested by the event, for example, a network connection process. On the other hand, if the determination result is indicative of prohibition of the event, the access detection/control module 10 cancels (prohibits) the execution of the process requested by the event, for example, a network connection process.

On the other hand, if the management application module 21 is already registered, the access detection/control module 10 transmits the event information indicative of the content of the detected event to the management application module 21 (step S37). The management application module 21 determines whether the determination application module 22 has already been registered (step S38).

If the determination application module 22 has not been registered, the management application module 21 determines permission or prohibition of the event, based on the default determination rule which is stored in the management application module 21 (step S39). On the other hand, if the determination application module 22 is already registered, the management application module 21 notifies the event information to the determination application module 22 (step S40). Based on the above-described rule set, the determination application module 22 determines permission or prohibition of the event designated by the event information (step S41). Then, the determination application module 22 transmits the determination result indicative of permission or prohibition of the event to the management application module 21 (step S42).

The management application module 21 transmits to the access detection/control module 10 the determination result based on the default determination rule or the determination result received from the determination application module 22 (step S43, S44). Based on the determination result received from the management application module 21, the access detection/control module 10 controls the execution of the process corresponding to the detected event (step S36).

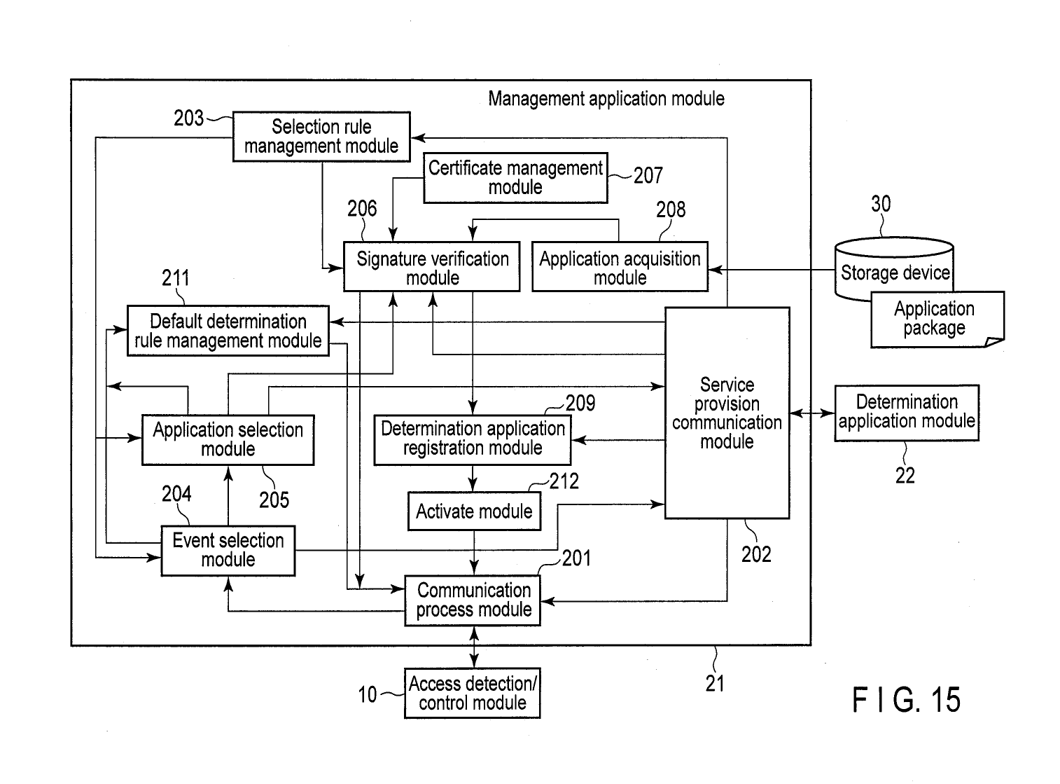

FIG. 15 illustrates another configuration of the management application module 21.

In the configuration of FIG. 13, when the management application module 21 is unable to communicate with the determination application module 22 because of some cause, or when the determination application module 22 is not registered in the determination application registration module 209 of the management application module 21, the default determination rule management module 211 transmits a determination result indicative of permission or prohibition of event to the access detection/control module 10 via the communication process module 201. In the configuration of FIG. 15, all events including an install event are processed by the default determination rule management module 211 of the management application module 21, unless an event registration request is received from the determination application module 22, not only in the case where the condition described in FIG. 13 is established, but also even in the case where the management application module 21 is communicable with the determination application module 22 and the determination application module 22 is registered in the determination application registration module 209 of the management application module 21.

In addition, in FIG. 13, the description has been given of the process procedure of executing signature verification in response to reception of the install event of the determination application, and confirming the integrity of the determination application. In the configuration of the management application module 21 of FIG. 15, the case is assumed that the process of confirming the integrity of the determination application is executed in response to reception of a registration request from the installed determination application.

Specifically, in the management application module 21 of FIG. 15, in the initial state (the state in which the determination application is not installed), none of install events, other than the install event of a specific application name, is notified from the access detection/control module.

The management application module 21 does not detect the install event itself of the determination application module 22. When a registration request has been transmitted from the determination application module 22 to the service provision communication module 202, the management application module 21 identifies the application name of the determination application module 22, and checks whether this application name agrees with the determination application name which is stored in the selection rule management module 203. If these agree, the management application module 21 executes the above-described signature verification by the signature verification module 206, thereby to confirm that the determination application module 22 is not a false determination application. If it is confirmed that the determination application module 22 is an authenticated determination application, the management application module 21 instructs, by the activate module 212, the access detection/control module 10 to transmit all events to the management application module 21.

Specifically, if the determination application module 22 is registered in the determination application registration module 209, the activate module 212 transmits an activation instruction to the access detection/control module 10 via the communication process module 201. Thereby, hereafter, the access detection/control module 10 notifies all events to the management application module 21. However, even if the determination application module 22 is registered in the determination application registration module 209, all events are processed by the management application module 21 until the event registration request is transmitted from the determination application module 22 to the management application module 21. In this case, the event selection module 204 and application selection module 205 notify, according to the rule of the selection rule management module 203, all events to the default rule determination module 211. The permission/prohibition of execution of each event is determined by the default rule determination module 211 according to the determination rule stored in the default rule determination module 211, and the determination result is transmitted to the access detection/control module 10 via the communication process module 201.

If the service provision communication module 202 receives the event registration request from the determination application module 22, the service provision communication module 202 updates the rule of the selection rule management module 203 in accordance with the event registration request. Thereby, hereafter, each event, which is designated by the event registration request, is transmitted to the determination application module 22. Specifically, the event selection module 204 and application selection module 205 determine, according to the rule of the selection rule management module 203, whether the received event is an event which is to be transmitted to the determination application module 22. If the received event is the event which is to be transmitted to the determination application module 22, the received event is transmitted to the determination application module 22 via the service provision communication module 202. On the other hand, if the received event is not the event which is to be transmitted to the determination application module 22, the received event is transmitted to the default determination rule management module 211.

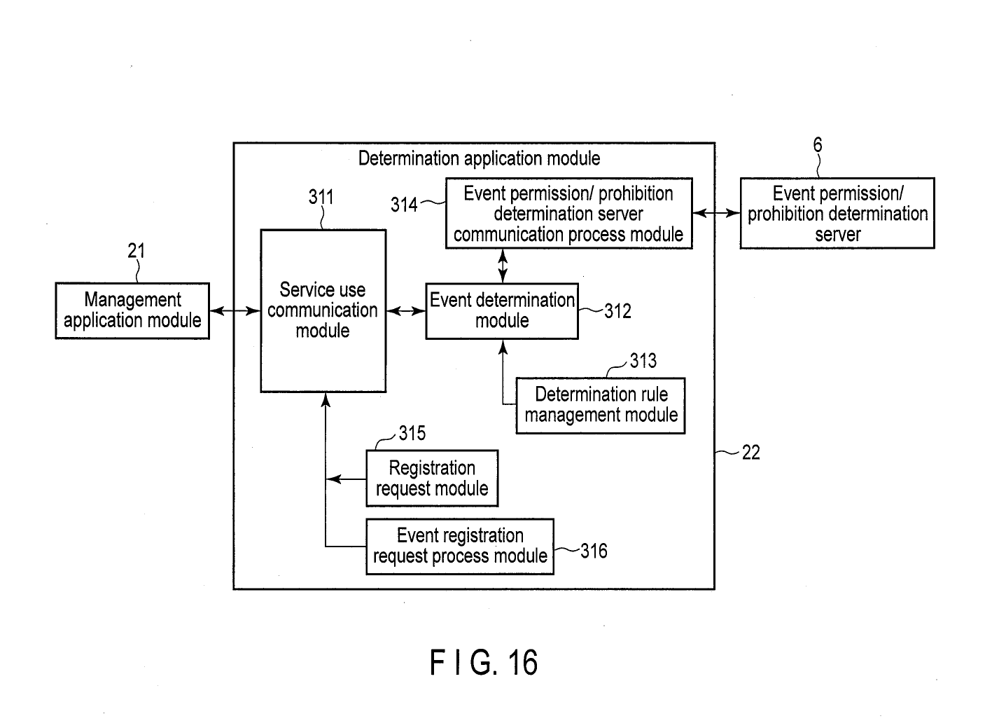

FIG. 16 illustrates a configuration of the determination application module 22 to which a registration request module 315 and an event registration request process module 316 are added.

The registration request module 115 is a process module which transmits, when the determination application module 22 is started, an instruction to the management application module 21 via a service use communication module 311, the instruction asking the management application module 21 to execute a registration process for registering the determination application module 22. The event registration request process module 316 transmits an event registration request, which is indicative of each event that is to be received, to the management application module 21 via the service use communication module 311.

The event registration request is a request asking the management application module 21 to give notification of each of events, for instance, a “request asking notification of an install event”, a “request asking notification of a WiFi® connection event”, a “request asking notification of an SD card connection event”, or a “request asking notification of a USB memory connection event”. Incidentally, the event registration request may be a request asking notification of all events.

If the determination application module 22 is registered in the management application module 21 and the event registration request is received from the determination application module 22, the management application module 21 transmits hereafter an event, which is designated by the event registration request, to the determination application module 22.

In the meantime, even if the management application module 21 receives from the determination application module 22 an event registration request asking notification of all events, the management application module 21 does not notify the determination application module 22 of an install event having a specific application name.

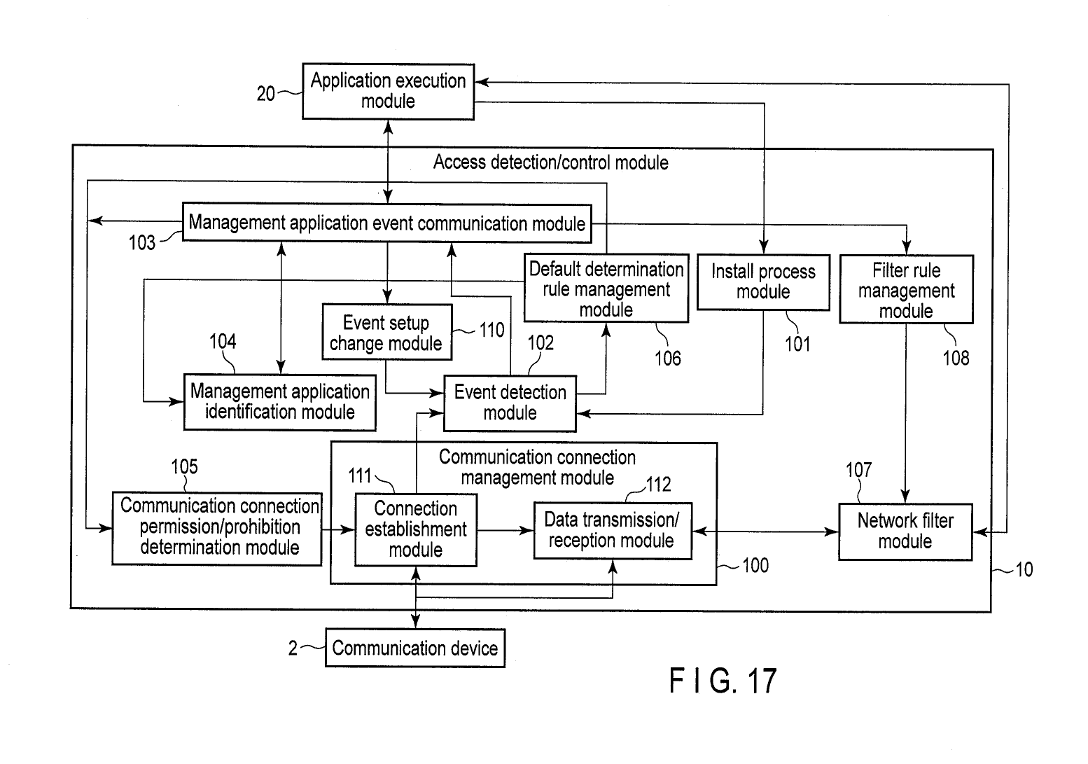

FIG. 17 illustrates a configuration of the access detection/control module 10 in which an event setup change module 110 is added.

The access detection/control module 10 of FIG. 12 transmits all install events to the management application module 21, thereby to determine permission/prohibition of update of the management application module 21 and to determine permission/prohibition of install of the determination application module. However, the access detection/control module 10 of FIG. 17 does not transmit events other than the install event, until receiving an activation instruction from the management application module 21. After receiving the activation instruction, the access detection/control module 10 first transmits events other than the install event to the management application module 21.

The event setup change module 110 sends to the event detection module 102 an instruction as to which event is to be transmitted to the management application module 21. Upon receiving the activation instruction from the management application module 21, the event setup change module 110 instructs the event detection module 102 to transmit all events to the management application module 21.

The configurations of FIG. 15, FIG. 16 and FIG. 17 are is particularly useful when one terminal is used both for business use and for consumer use. In general, in the consumer use, there is no need to restrict the execution of an event which is detected by the event detection module 102 of the access detection/control module 10, such as install or launch of an application or a network connection. At this time, if the determination application module 22 is not installed, the determination application module 22 does not transmit the registration request to the management application module 21, and the management application module 21 does not transmit the activation instruction to the access detection/control module 10, and as a result the permission/prohibition of the event is determined according to the initial rule of the event setup change module 110. At this time, it should suffice if a rule which does not impose restriction (prohibition) is set in the event setup change module 110. Thereby, in the case of use by general consumers, the event detected in the event detection module 102 is not particularly restricted. On the other hand, in the case where the information processing apparatus 1 is used for business work in a company, it is necessary to impose various restrictions on the terminal according to the security policy of the IT (Information Technology) administrator. In this case, the determination application module 22 including a determination rule according to the security policy of each company is installed. If the determination application module 22 transmits a registration request to the management application module 21 and the management application module 21 transmits an activation instruction to the access detection/control module 10, an event which is detected hereafter by the event detection module 102 is transmitted to the management application module 21. If the determination application module 22 transmits an event registration request to the management application module 21, each event, which is transmitted from the access detection/control module 10, is transmitted to the determination application module 22 via the management application module 21, and the permission/prohibition of each event is determined based on the determination rule according to the security policy of each company.

Furthermore, the determination application module 22 can receive only an event, which is to be received, from the management application module 21, by designating an event, the notification of which is to be requested, to the management application module 21 by the above-described event registration request. Thus, since an event, which does not need to be particularly restricted, is processed by the default rule determination module 211 of the management application module 21, no communication is needed between the management application module 21 and determination application module 22, thereby enabling quick determination and enhancing the processing speed of the apparatus. The determination application module 22 can notify the management application module 21 of the event that is to be received, by the above-described event registration request.

Besides, such an instruction as to update the determination rule of the default determination rule management module 211 may be included in the event registration request of the determination application module 22. As described above, the determination rule of the default determination rule management module 211 of the management application module 21 is used both in the state that the determination application module 22 is not registered in the determination application registration module 209 and in the state that the management application module 21 has become unable to communicate with the determination application registration module 209 because of some cause after the determination application module 22 was registered in the determination application registration module 209. The instruction as to update the determination rule of the default determination rule management module 211 can change the determination rule under these two states. For example, in the state in which the determination application module 22 is not registered in the determination application registration module 209, events are not restricted (uninstall, WiFi® connection, SD card connection, or USB memory connection is permitted) since the apparatus 1 is used for general consumers. However, after the determination application module 22 is registered in the determination application registration module 209, since the apparatus 1 is used for business purposes, the determination rule may be changed to restrict events when the management application module 21 has become unable to communicate with the determination application registration module 209 for some reason.

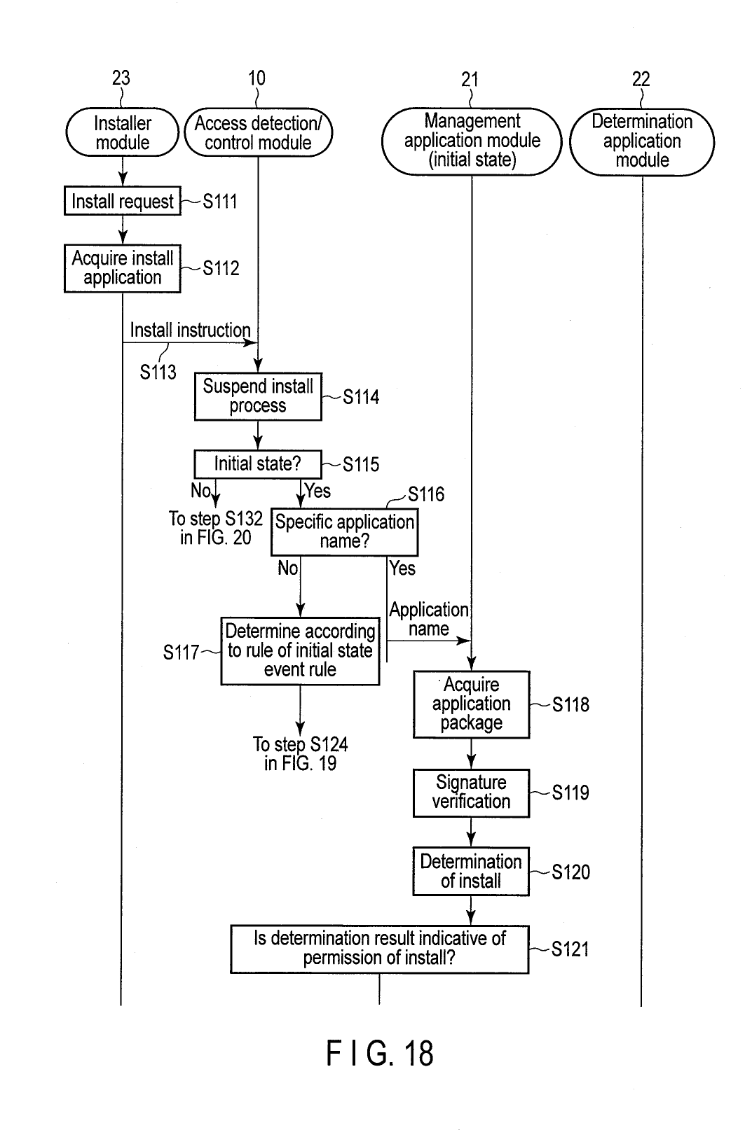

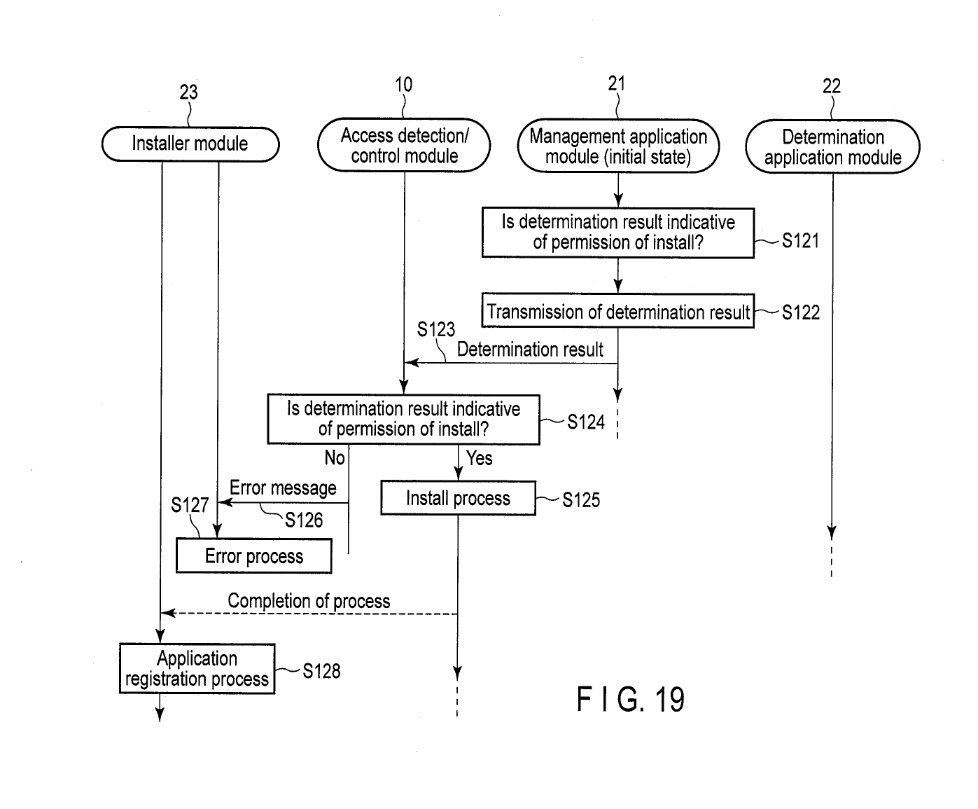

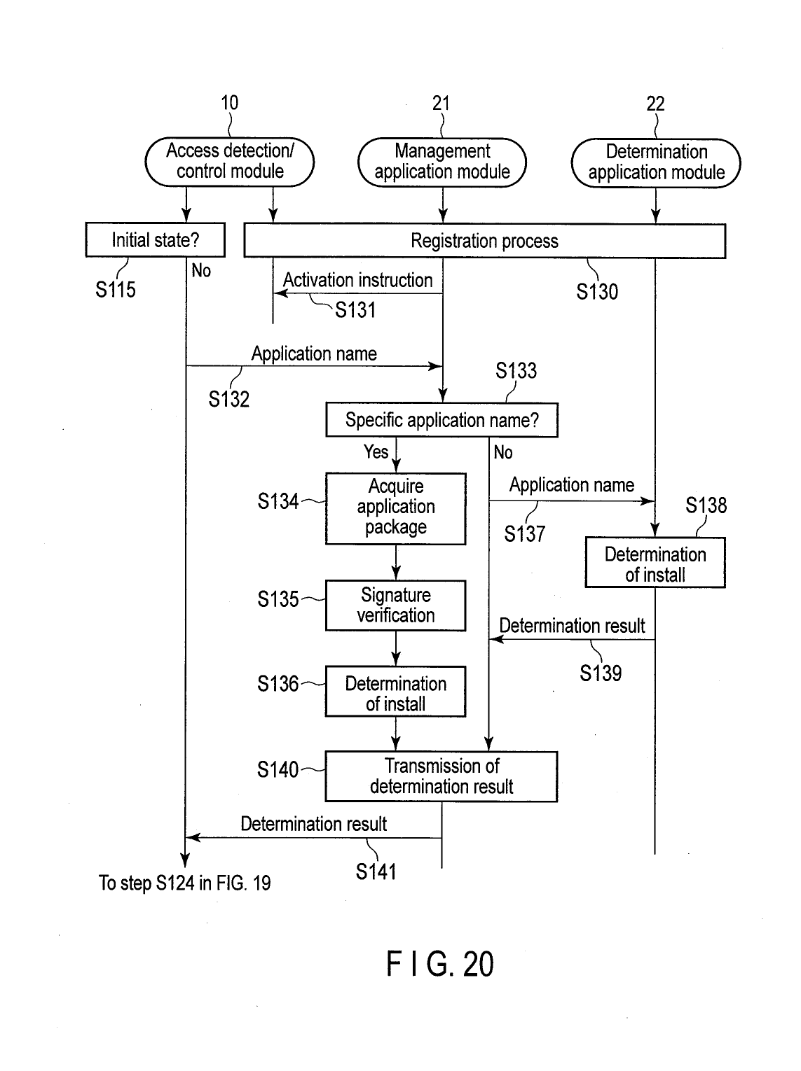

Next, referring to flowcharts of FIG. 18, FIG. 19 and FIG. 20, a description is given of the procedure of the process which is executed by the installer module 23, access detection/control module 10, management application module 21 and determination application module 22.

If an install request occurs in accordance with an application install operation by the user (step S111), the installer module 23 acquires an application package file corresponding to an application that is an install target (step S112). Then, the installer module 23 transmits an install instruction for install of the install-target application to the access detection/control module 10 (step S113).

Upon receiving the install instruction, the access detection/control module 10 detects the occurrence of an event of requesting install of the application. The access detection/control module 10 suspends the execution of the install process (step S114).

The access detection/control module 10 determines whether the access detection/control module 10 is in an inactivated state (initial state) or not (step S115). If the access detection/control module 10 is in the inactivated state (initial state), the access detection/control module 10 determines whether the application, which is to be installed by the installer module 23, is the application having the above-described specific application name (step S116).

If the application, which is to be installed by the installer module 23, is not the application having the above-described specific application name, the access detection/control module 10 determines permission or prohibition of the install event, according to the initial state event rule stored in the access detection/control module 10 (step S117). This initial state event rule is a rule for the access detection/control module 10 to determine permission/prohibition of each event in the initial state. The initial state event rule may be stored in the event setup change module 110 or the default determination rule management module 106.

On the other hand, if the application, which is to be installed, is the application having the above-described specific application name, the access detection/control module 10 transmits the install event and the above-described specific application name as the install event information to the management application module 21.

The management application module 21 acquires an application package file corresponding to the application name included in the install event information which is received from the access detection/control module 10 (step S118), and executes signature verification for confirming the integrity of the application that is to be installed by the installer module 23, by using the certificate (signature) given to the application package file and the public key corresponding to the certificate (signature) (step S119). Then, the management application module 21 confirms the result of the signature verification (step S120), and determines whether or not to permit install, in accordance with the result of the signature verification (step S121).

Then, as illustrated in FIG. 19, the management application module 21 transmits the determination result to the access detection/control module 10 (step S122). The determination result is transmitted to the access detection/control module 10 via the communication process module 201 in the management application module 21 (step S123).

The access detection/control module 10 determines whether the determination result (the determination result based on the initial state event rule, or the determination result received from the management application module 21) is indicative of permission of install (step S124). If the determination result is indicative of prohibition of install (No in step S124), the access detection/control module 10 returns an error message to the installer module 23, without executing the install process of the install-target application (step S126). The installer module 23 executes an error process, such as notifying the user of the error of install (step S127).

On the other hand, if the determination result is indicative of permission of install (Yes in step S124), the access detection/control module 10 executes the install process for installing the install-target application (step S125). In the install process, for example, a file corresponding to the application package file is created at a predetermined directory. Then, if the install process is completed, the installer module 23 registers, for instance, a thumbnail image file in the application package file in the application information storage module (step S128).

As illustrated in FIG. 20, if the determination application module 22 is installed, a registration process for registering the determination application module 22 in the management application module 21 is started (step S130). The management application module 21 transmits an activation instruction to the access detection/control module 10 (step S131).

When the access detection/control module 10 is in the activated state, that is, when the access detection/control module 10 is not in the initial state (No in step S115), the access detection/control module 10 transmits all of the events that have occurred to the management application module 21. For example, if an install event of a certain application has occurred, the access detection/control module 10 transmits the install event and the application name of the application, which is to be installed, to the management application module 21 as the install event information (step S132).

The management application module 21 determines whether the application name (the application to be installed by the installer module 23) included in the install event information, which is received from the access detection/control module 10, is the specific application name (step S133).

If the application, which is to be installed by the installer module 23, is the specific application name (Yes in step S133), the management application module 21 acquires an application package file corresponding to the specific application name (step S134), and executes signature verification for confirming the integrity of the application that is to be installed by the installer module 23, by using the certificate (signature) given to the application package file and the public key corresponding to the certificate (signature) (step S135). Then, the management application module 21 confirms the result of the signature verification, and determines whether or not to permit install, in accordance with the result of the signature verification (step S136).

On the other hand, if the application, which is to be installed by the installer module 23, is not the specific application name (No in step S133), the management application module 21 notifies the install event information to the determination application module 22 (step S137). Based on the application name included in the install event information, the determination application module 22 determines permission or prohibition of install of the application (step S138). The management application module 21 receives the determination result indicative of permission or prohibition of install from the determination application module 22 (step S139).

The management application module 21 transmits to the access detection/control module 10 the determination result by the signature verification module 206 in the management application module 21, or the determination result by the determination application module 22 (step S140). The determination result is transmitted to the access detection/control module 10 via the communication process module 201 in the management application module 21 (step S141). Then, the access detection/control module 10 executes the process of step S124 onwards in FIG. 19.

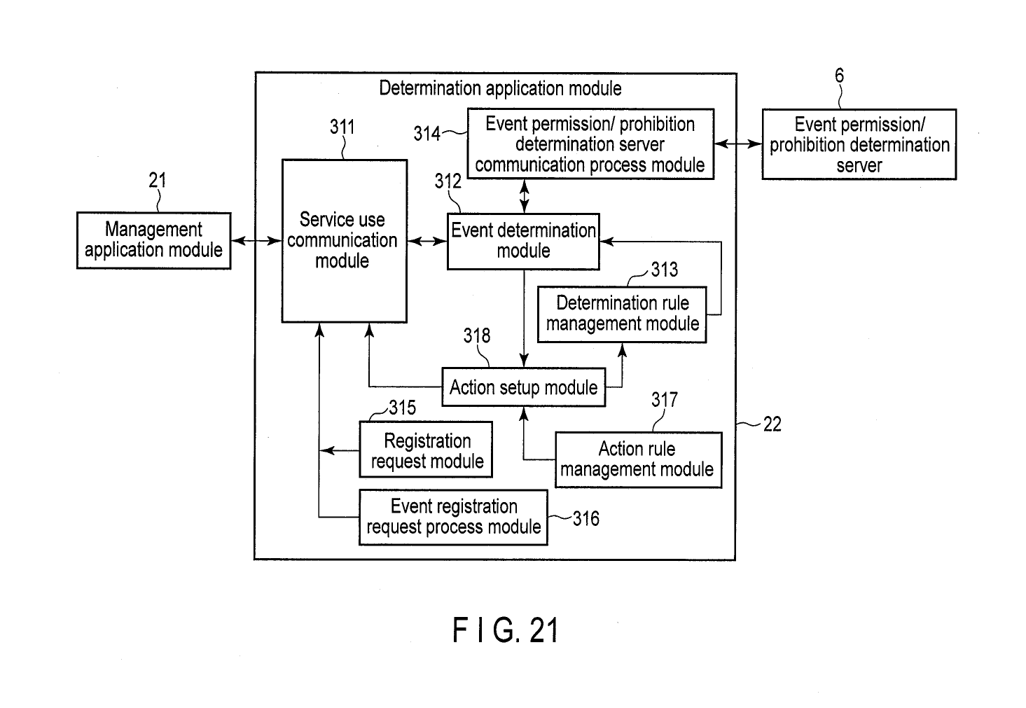

FIG. 21 shows a configuration of the determination application module 22 in which an action rule management module 317 and an action setup module 318 are added.

The determination application module 22 is configured not only to determine, when certain event information has been received, permission or prohibition of an event of the event information, but also to execute a predetermined action in response to the determination of permission of the event. The action rule management module 317 stores an action rule which defines the content of an action that is to be executed in association with each of some specific events. The action setup module 318 determines an action which is to be executed, based on the action rule, in response to determination of permission of a certain event, and notifies the determined action to the management application module 21 or updates the rule of the determination rule management module 313 based on the content of the determined action.

For example, if a process corresponding to a certain specific event (first event) has been permitted, the action setup module 318 executes a process for dynamically changing the content of a determination result for another event (second event) which requests execution of a specific process. Thereby, the execution of a specific event, which has been prohibited, can be permitted, or the execution of a specific event, which has been permitted, can be prohibited.

As the first event, for example, use may be made of a network connection event which requests a connection to a specific external communication device. Thereby, for example, after an event of requesting a connection to a specific WiFi® access point has been detected and this event has been permitted, the launch (start) of an application, which has been prohibited, can be permitted, or the connection of a USB memory, which has been permitted, can be prohibited.

For example, in the case where a WiFi® access point in a company was set as the above-described specific WiFi® access point, an event of requesting a connection to the above-described specific WiFi® access point occurs when the information processing apparatus 1 is used in the company. It is thus possible to automatically detect such a situation that the information processing apparatus 1 is used in the company, and to automatically execute, responding to this detection, (a) switching of enabling/disabling of install restriction, (b) switching of enabling/disabling of application launch restriction, (c) addition or change of an IP address and a port number, the connection to which is prohibited, (d) switching of enabling/disabling of application uninstall restriction, (e) switching of enabling/disabling of SD memory card connection restriction, (f) switching of enabling/disabling of USB memory connection restriction, and (g) switching of enabling/disabling of a proxy. For example, the following actions can be executed.

(1) When the information processing apparatus 1 has been connected to a specific WiFi® access point, application launch restriction is enabled, and the list of external communication devices, the connection to which is permitted, is updated (in a company, launch of a game application is prohibited, and a connectable external communication device is restricted).

(2) When the information processing apparatus 1 has been connected to a specific Bluetooth® device, launch of a VPN (Virtual Private Network) application is permitted (a specific Bluetooth® device is used as a token).

(3) When the information processing apparatus 1 has been connected to a specific WiFi® access point, application uninstall restriction is disabled.

(4) When the information processing apparatus 1 has been connected to a specific WiFi® access point, a connection is enabled to only a specific IP address and port number (in a company, a server of a connection destination is restricted).

(5) When the information processing apparatus 1 has been connected to a specific WiFi® access point, the use of an SD memory card/USB memory is prohibited (takeout of information is prohibited).

(6) When the information processing apparatus 1 has been connected to a specific WiFi® access point, launch of a specific application is permitted (the use of a business application is permitted only in a company).

The case is now assumed that in response to an event (first event) of requesting a connection to a specific external communication device, the content of a determination result for a second event of requesting execution of a specific process is dynamically changed. In this case, if the first event is detected by the access detection/control module 10 and the event information of the first event is sent to the determination application module 22 via the management application module 21, the determination application module 22 outputs a determination result indicative of permission of the first event and updates the determination result for the second event, for example, from prohibition to permission, or from permission to prohibition. Accordingly, since the management application module 21 transmits to the access detection/control module 10 the determination result which has been received from the determination application module 22, the management application module 21, as a result, operates in the following manner.

Specifically, when the event detected by the access detection/control module 10 is an event (first event) of requesting a connection to a specific external communication device, the management application module 21 transmits to the access detection/control module 10 a determination result indicative of permission of the connection to this specific external communication device.

When the event detected by the access detection/control module 10 is an event (second event) requesting execution of a specific process and the connection to the above-described specific external communication device is not permitted, that is, when the second event has been detected before the detection of the first event, the management application module 21 transmits to the access detection/control module 10 a determination result indicative of one of permission and prohibition of execution of the above-described specific process, according to a determination result for the second event which is obtained from the determination application module 22.

When the event detected by the access detection/control module 10 is the above-described second event and the connection to the above-described specific external communication device is permitted, that is, when the second event has been detected after the detection of the first event, the management application module 21 transmits to the access detection/control module 10 a determination result indicative of the other of permission and prohibition of execution of the above-described specific process, according to a determination result for the second event which is obtained from the determination application module 22.

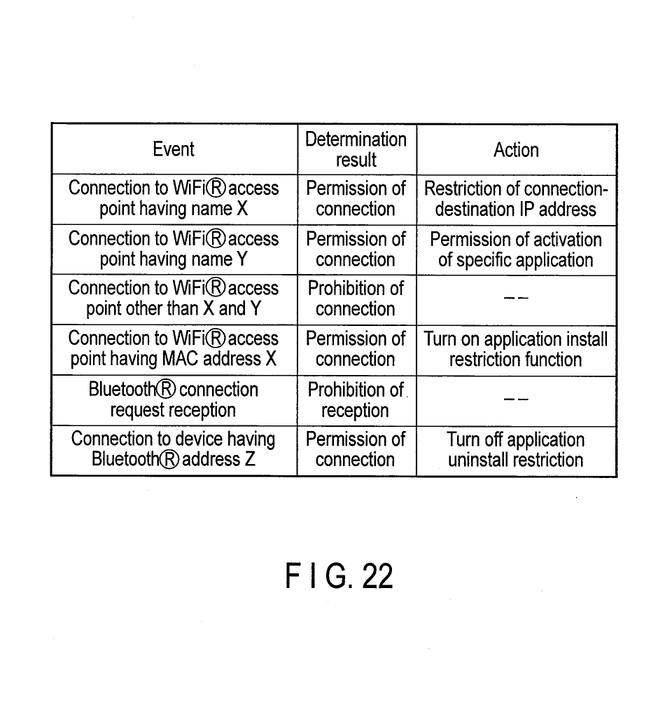

FIG. 22 shows rules which are stored in the determination application module 22 of FIG. 21, that is, the relationship between events, determination results, and actions.

The respective event contents can be classified as follows:

(1) WiFi® connection,

(2) a combination of WiFi® connection and an access point name,

(3) a combination of WiFi® connection and an address (MAC address),

(4) a combination of WiFi® connection, an access point name and an address (MAC address),

(5) Bluetooth® connection,

(6) Bluetooth® connection request reception,

(7) a combination of Bluetooth® connection request reception, and an address of a Bluetooth® device at a source of transmission of a Bluetooth® connection request,

(8) Bluetooth® connection request transmission, and

(9) a combination of Bluetooth® connection request transmission, and an address of a Bluetooth® device at a destination of transmission of a Bluetooth® connection request.

An arbitrary combination of (1) to (9) may be used as an event.

The contents of actions, that is, the contents of process restrictions, the enabling/disabling of which can be switched, are as follows:

(a) application launch restriction (an application, which is not on the list, must not be activated),

(b) restriction of a connection-destination IP address and port number,

(c) application install restriction,

(d) application uninstall restriction,

(e) SD memory card connection prohibition,

(f) USB memory connection prohibition, and

(g) enabling of a proxy (communication with only a set-up proxy server is permitted).

In FIG. 22, ‘connection to a WiFi® access point having an access point name “X”’, ‘connection to a WiFi® access point having an access point name “Y”’, ‘connection to a WiFi® access point having a MAC address “X”’, and ‘connection to a device having a Bluetooth® address “Z”’ are defined as the above-described first events.

For example, if an event of ‘connection to a WiFi® access point having an access point name “X”’ has been detected, this event is permitted. Further, hereafter, a connection to a server having a specific IP address, which has been permitted, is prohibited. Incidentally, the connection may be restricted by a port number in addition to the IP address. If an event of ‘connection to a WiFi® access point having an access point name “Y”’ has been detected, this event is permitted. Further, hereafter, launch of a specific application, which has been prohibited, is permitted.

In this manner, in the present embodiment, the permission or prohibition of connection can be controlled with respect to each of network connection events, and the behavior of the information processing apparatus 1 can be dynamically changed in accordance with, for example, a WiFi® access point which is connected to the information processing apparatus 1.

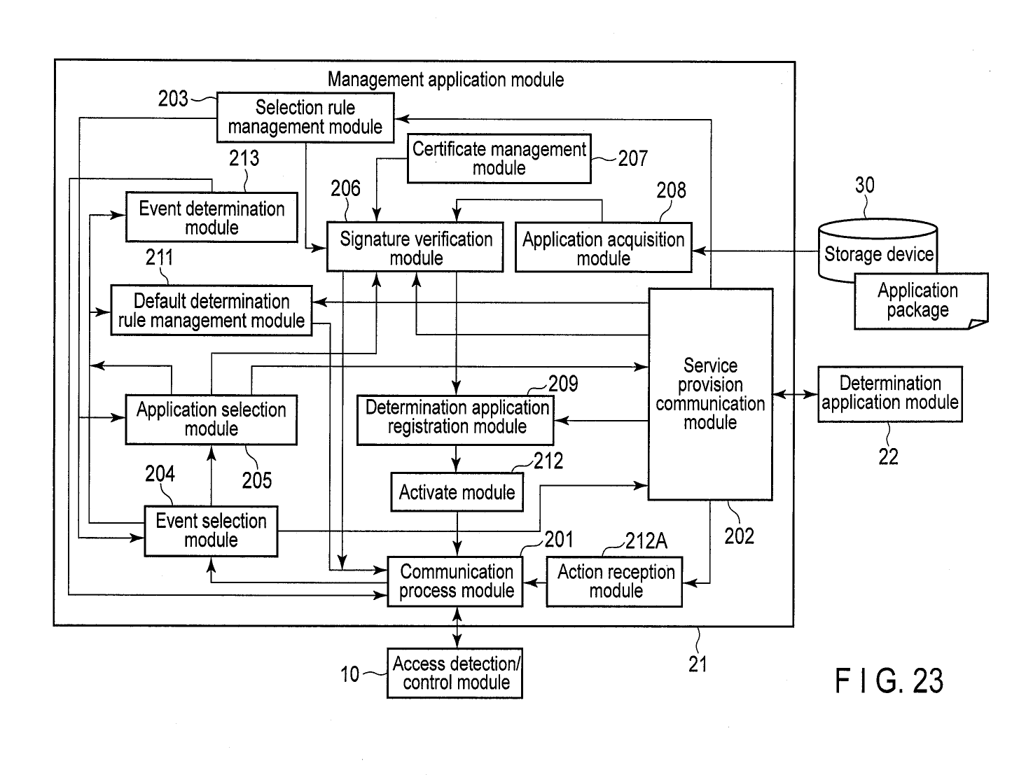

FIG. 23 shows a configuration of the management application module 21 in which an action reception module 212A and an event determination module 213 are added.

The management application module 21 receives a determination result and an action from the determination application module 22. When there is no action, a determination result is notified from the service provision communication module 202 to the communication process module 201. When there is an action, the action reception module 212A receives the action from the determination application module 22 via the service provision communication module 202. The received action is transmitted to the access detection/control module 10 via the communication process module 201. The access detection/control module 10 can execute the received action. Thereby, hereafter, the permission or prohibition of some specific events can be determined in the access detection/control module 10.

The event determination module 213 in the management application module 21 can execute the same process as the event determination module 312 in the determination application module 22. The rules of the selection rule management module 203 may be changed in accordance with actions, so that the permission/prohibition of some specific events may be determined by the event determination module 213. In addition, the rules of the default determination rule management module 211 may be changed in accordance with actions, so that the permission/prohibition of some specific events may be determined by the management application module 21.

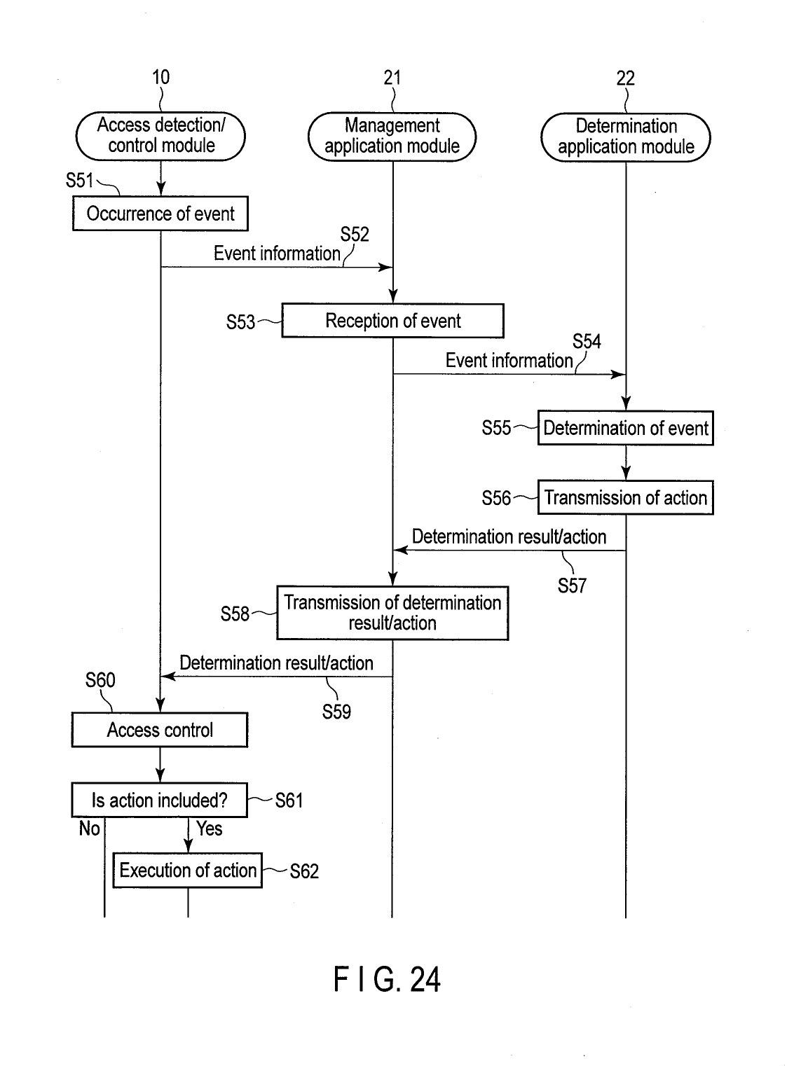

Next, referring to a flowchart of FIG. 24, a description is given of still another example of the procedure of the process which is executed by the access detection/control module 10, management application module 21 and determination application module 22.

If the occurrence of an event, such as a network connection event, is detected (step S51), the access detection/control module 10 transmits event information indicative of the content of the detected event to the management application module 21 (step S52). The management application module 21 receives the event information (step S53) and notifies the received event information to the determination application module 22 (step S54). Based on the above-described rule set, the determination application module 22 determines permission or prohibition of the event that is designated by the event information (step S55). Then, if this event is a specific event which is associated with an action, the determination application module 22 transmits the action corresponding to this event to the management application module 21 (step S56). Thereby, when the event detected by the access detection/control module 10 is a specific event, the determination result including an action is transmitted from the determination application module 22 to the management application module 21 (step S57).

The management application module 21 transmits the received determination result (or the determination result including the action) to the access detection/control module 10 (step S58, S59). Based on the determination result received from the management application module 21, the access detection/control module 10 controls the execution of the process corresponding to the detected event (step S60). Then, the access detection/control module 10 determines whether an action is included in the received determination result (step S61). If an action is included in the received determination result, the action detection/control module 10 executes the action (step S62).

For example, as the action, use is made of an action of restricting a connection-destination IP address and port number. Specifically, this action is an action of prohibiting a connection using a specific port number to a Web site having a specific IP address, in response to a connection to a certain WiFi® access point. This action (IP address/port number restriction) is processed in the access detection/control module 10, and the filter rule management module 108 of the access detection/control module 10 is updated and the updated filter rule is set for the network filter module 107. Thereby, the access detection/control module 10 executes the process of prohibiting the connection using the specific port number to the Web site having the specific IP address.

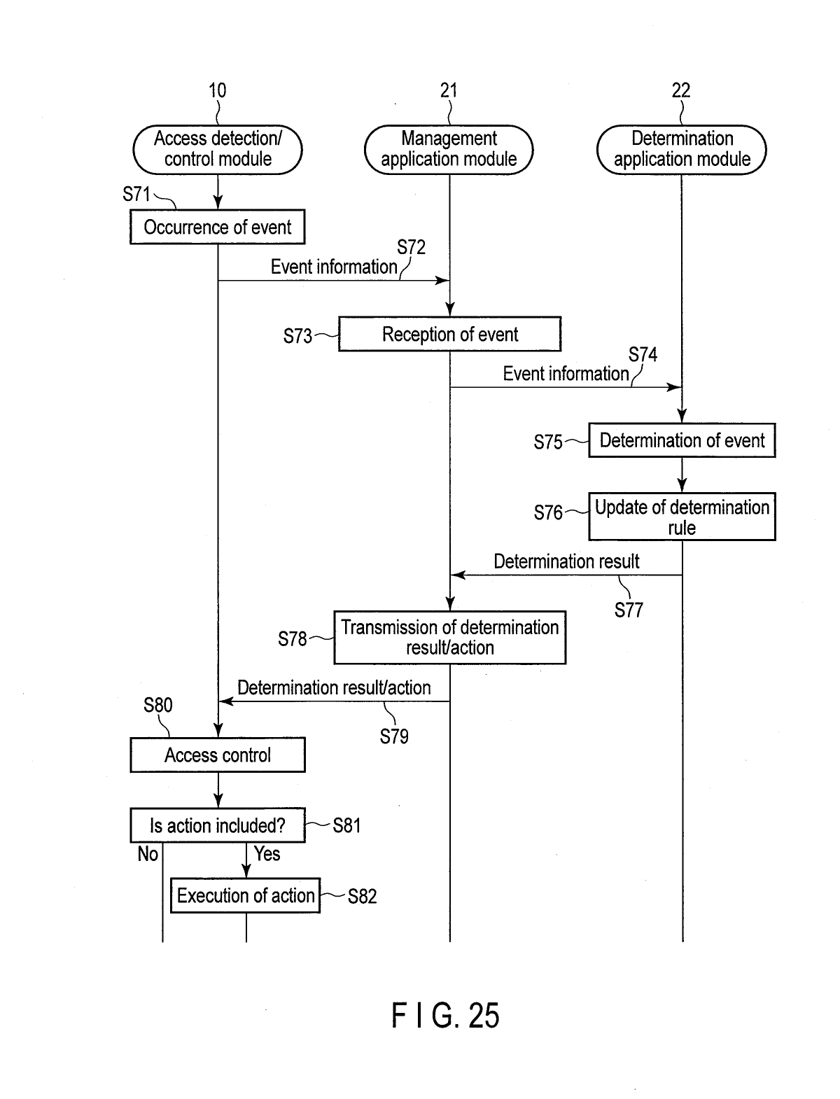

Next, referring to a flowchart of FIG. 25, a description is given of still another example of the procedure of the process which is executed by the access detection/control module 10, management application module 21 and determination application module 22.

If the occurrence of an event, such as a network connection event, is detected (step S71), the access detection/control module 10 transmits event information indicative of the content of the detected event to the management application module 21 (step S72). The management application module 21 receives the event information (step S73) and notifies the received event information to the determination application module 22 (step S74). Based on the above-described rule set, the determination application module 22 determines permission or prohibition of the event that is designated by the event information (step S75). Then, if this event is a specific event which is associated with an action, the determination application module 22 updates, in accordance with this event, the determination rule which is stored in the determination application module 22 (step S76). For example, if an event of requesting a connection to a specific WiFi® access point is detected, the determination application module 22 may update the determination rule thereof, and may execute a process of adding an application on the black list of application names the launch of which is to be prohibited (the launch of a game application is prohibited while working). The connection to the specific WiFi® access point requested by the event is permitted. Then, only the determination result is transmitted from the determination application module 22 to the management application module 21 (step S77).

The management application module 21 has, for example, an action of “prohibiting a connection to a specific IP address and port number in accordance with a connection-destination WiFi® access point”, and transmits the received determination result and this action to the access detection/control module 10 (step S78, S79). The content of the action is “prohibition of connection to specific IP address”.

Based on the determination result received from the management application module 21, the access detection/control module 10 controls the execution of the process corresponding to the detected event (step S80). Then, the access detection/control module 10 determines whether an action is included in the received determination result (step S81). If an action is included in the received determination result, the action detection/control module 10 executes the action (step S82). As a result, the filter rule management module 108 of the access detection/control module 10 is updated, and thereby the access detection/control module 10 executes the process of prohibiting the connection to the server having the specific IP address.

Similarly, the management application module 21 has, for example, an action of “setting up execution of HTTP communication with a proxy server of IP address A and TCP port B, in accordance with a connection-destination WiFi® access point”, and transmits the received determination result and this action to the access detection/control module 10 (step S78, S79). The content of the action is “setting up HTTP proxy server at IP address A and TCP port B”.

The access detection/control module 10 sets, in the proxy setup module 109, the IP address A and TCP port B as the IP address and TCP port number of the HTTP proxy server. Hereafter, when communication is executed by the protocol of HTTP, the communication is always executed via the proxy server of the IP address A and TCP port B. Thereby, if a user in the company establishes a connection to a wireless LAN access point in the company, the setup of the proxy is automatically performed. Thus, the convenience for the user is enhanced. Moreover, since the information processing apparatus 1 always executes communication via the proxy server, the network security administrator in the company can also monitor usage information, such as browsing of inappropriate Web sites, and therefore the security can be enhanced.

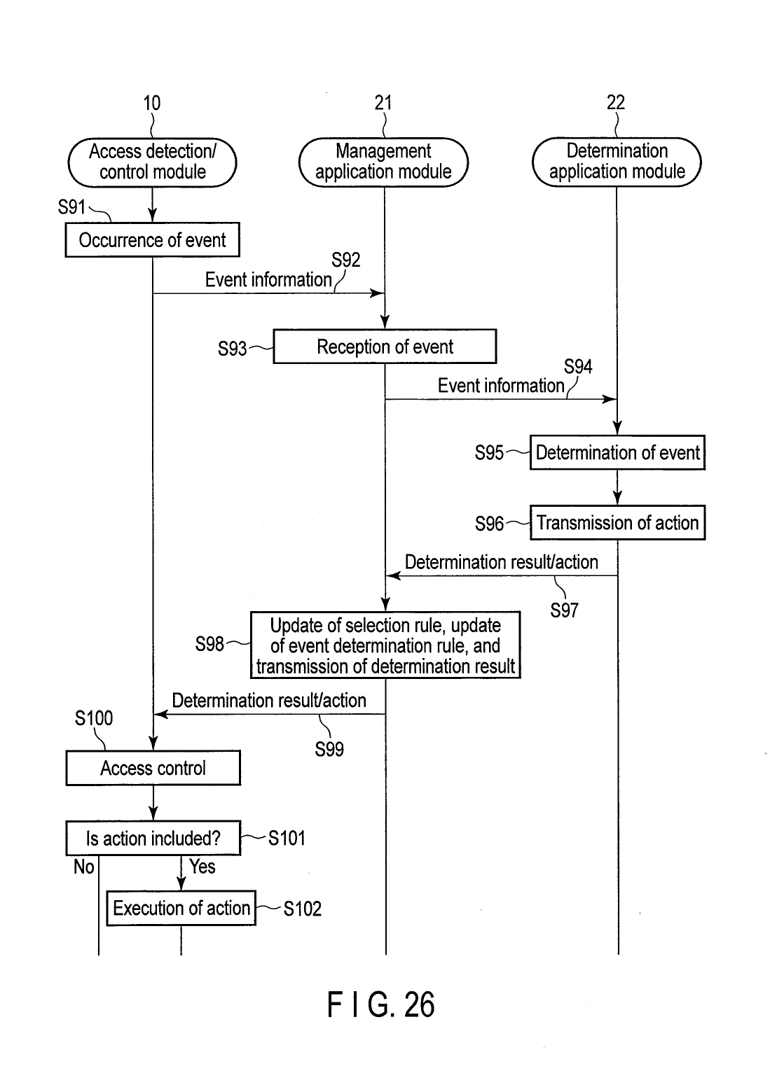

Next, referring to a flowchart of FIG. 26, a description is given of still another example of the procedure of the process which is executed by the access detection/control module 10, management application module 21 and determination application module 22.

If the occurrence of an event, such as a network connection event, is detected (step S91), the access detection/control module 10 transmits event information indicative of the content of the detected event to the management application module 21 (step S92). The management application module 21 receives the event information (step S93) and notifies the received event information to the determination application module 22 (step S94). Based on the above-described rule set, the determination application module 22 determines permission or prohibition of the event that is designated by the event information (step S95). Then, if this event is a specific event which is associated with an action, the determination application module 22 transmits the action corresponding to this event to the management application module 21 (step S96). Thereby, when the event detected by the access detection/control module 10 is a specific event, the determination result including an action is transmitted from the determination application module 22 to the management application module 21 (step S97).

The management application module 21 updates, according to the received action, the determination rule (selection rule, event determination rule) which is stored in the management application module 21 (step S98). For example, an application install event has been hitherto transmitted from the management application module 21 to the determination application module 22. However, a rule that “install of a specific application is permitted if a connection to a specific WiFi® access point is established” is set in the event determination module 213 of the management application module 21, and if the corresponding install event is received, the management application module 21, and not the determination application module 22, determines permission of install of the specific application, and transmits the determination result to the access detection/control module 10. In this case, since no communication occurs between the management application module 21 and determination application module 22, the process can quickly be executed.

The management application module 21 transmits to the access detection/control module 10 a determination result indicative of permission of the connection to the specific WiFi® access point (step S99). In the meantime, depending on an action which is received from the determination application module 22, the determination result including the action may be transmitted to the access detection/control module 10, like step S59 in FIG. 24.

Based on the determination result received from the management application module 21, the access detection/control module 10 controls the execution of the process corresponding to the detected event (step S100). Then, the access detection/control module 10 determines whether an action is included in the received determination result (step S101). If an action is included in the received determination result, the action detection/control module 10 executes the action (step S102).

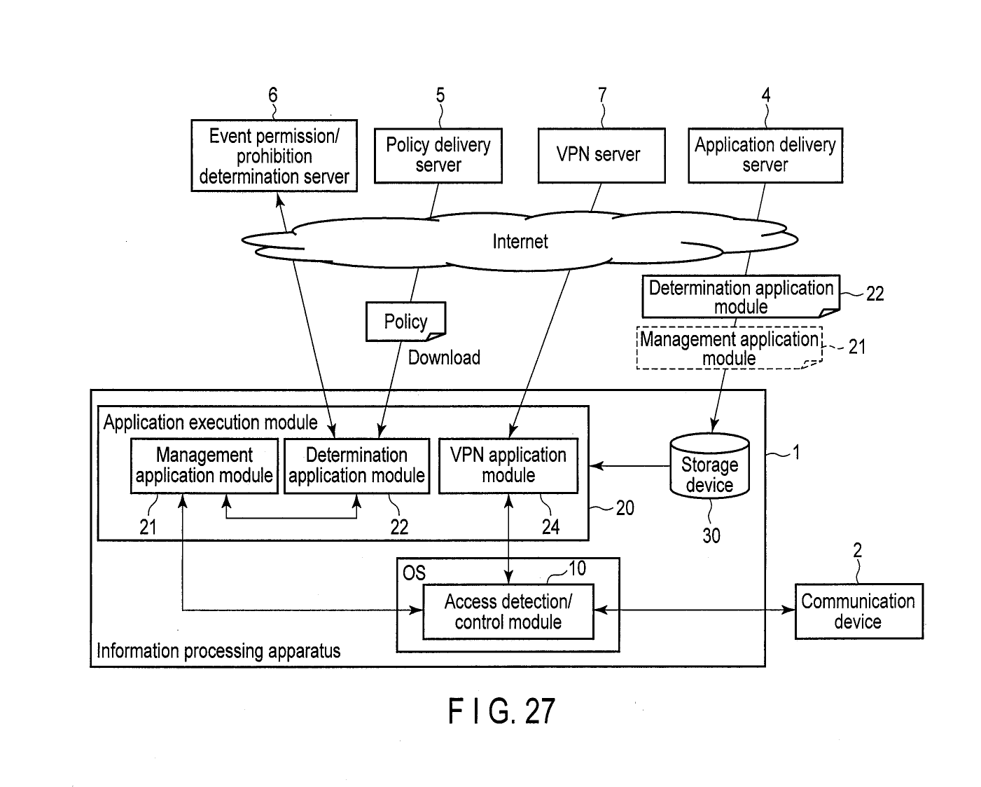

FIG. 27 illustrates another configuration of the information processing apparatus 1. In the information processing apparatus 1 of FIG. 27, a VPN (Virtual Private Network) application module 24 is executed on the application execution module 20. The VPN application module 24 is also an application program. The VPN application module 24 is a VPN setup application, transmits VPN setup and a VPN connection instruction to a VPN client of the access detection/control module 10, and communicates with a VPN server 7 via the Internet, thereby establishing a VPN connection. The VPN server 7 may be a server in a company in which the information processing apparatus 1 is used for BYOD (Bring Your Own Device). The user of the information processing apparatus 1 can establish a connection to the VPN server 7 from home. Incidentally, although the installer module 23 is not illustrated in FIG. 27, the installer module 23 may also be executed on the application execution module 20 in the configuration of FIG. 27.

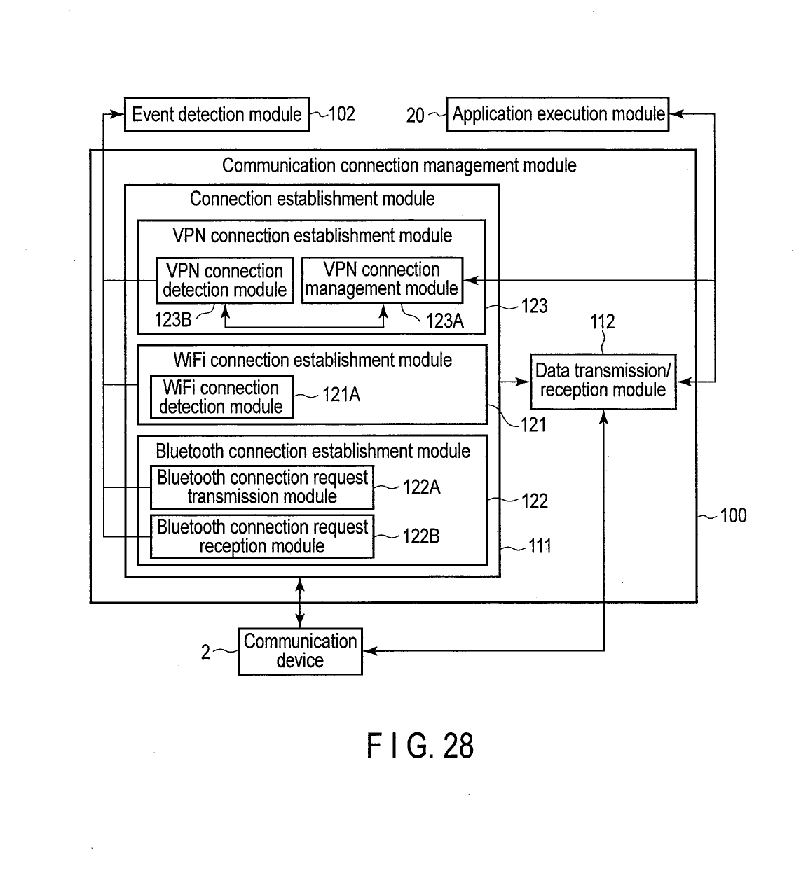

FIG. 28 shows a configuration example of the communication connection management module 100 provided in the access detection/control module 10 of the information processing apparatus 1 of FIG. 27. This communication connection management module 100 includes a VPN connection establishment module 123, in addition to the above-described WiFi® connection establishment module 121 and Bluetooth® connection establishment module 122.

The VPN connection establishment module 123 is a so-called VPN client. A VPN connection management module 123A in the VPN connection establishment module 123 establishes a VPN connection, based on a request from the VPN application module 24 and, if the VPN connection has been established, the VPN connection management module 123A notifies a VPN connection detection module 123B of the established VPN connection. The VPN connection detection module 123B detects the VPN connection, and transmits the detected VPN connection to the event detection module 102. The event detection module 102 transmits event information indicative of the VPN connection to the management application module 21. This event information includes establishment of VPN connection and a communication-destination IP address.

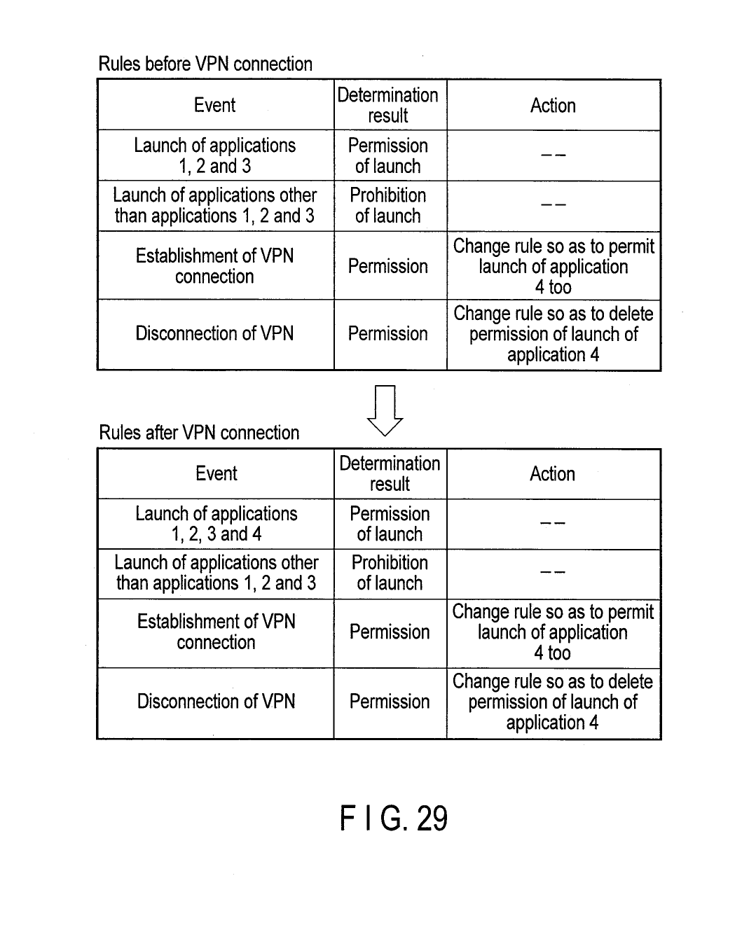

FIG. 29 shows the contents of determination rules in the determination application module 22 before VPN connection, and the contents of the change of the determination rules after VPN connection.

In FIG. 29, application “1” and application “2” are system applications, and application “3” is a VPN application. Specifically, in the initial state (before VPN connection), only the VPN application can be activated. After VPN connection, the launch of application 4 is permitted. For example, assume that application 4 is an application, the use of which is permitted only in an intra-company network, such as an application which operates a personnel information management database. It is possible to realize such a scene of use that the launch of application 4 is not permitted while the information processing apparatus 1 is being connected to an external network outside the company, such as a home network of the user, but the launch of application 4 is permitted if a connection to the intra-company network from the external network has successfully been established by VPN. In this example, the rule set (determination rules), which is stored in the determination application module 22, is changed. However, the determination application module 22 may transmit an action to the management application module 21, responding to reception of an event of VPN connection, so that the rule set stored in the management application module 21 may be changed.

If an event of VPN disconnection is received after the change of the rule set, the contents of the rule set stored in the determination application module 22 are restored to the contents of the rule set in the initial state (before VPN connection).

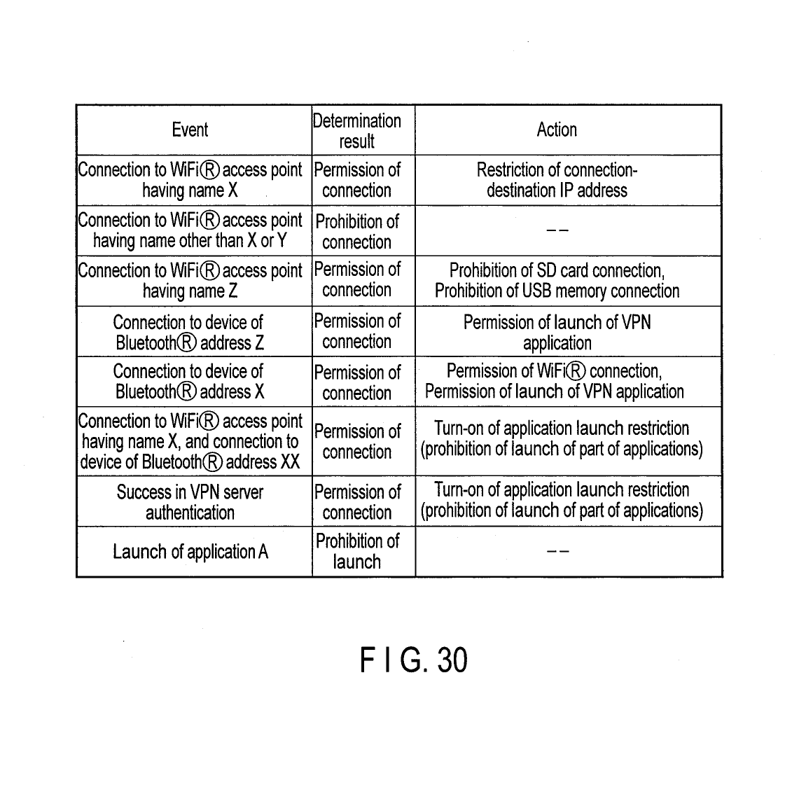

FIG. 30 shows another example of the rules which are stored in the determination application module 22, that is, the relationship between events, determination results, and actions.

The respective event contents can be classified as follows:

(1) WiFi® connection,

(2) a combination of WiFi® connection and an access point name,

(3) a combination of WiFi® connection and an address (MAC address),

(4) Bluetooth® connection request reception,

(5) a combination of Bluetooth® connection request reception, and an address of a Bluetooth® device at a source of transmission of a Bluetooth® connection request,

(6) Bluetooth® connection request transmission,

(7) a combination of Bluetooth® connection request transmission, and an address of a Bluetooth® device at a destination of transmission of a Bluetooth® connection request,

(8) Success in VPN server authentication, and

(9) Launch of a specific application.

An arbitrary combination of (1) to (9) may be used as an event.

The contents of actions, that is, the contents of process restrictions, the enabling/disabling of which can be switched, are as follows:

(a) application launch restriction (an application, which is not on the list, must not be launched),

(b) restriction of a connection-destination IP address and port number,

(c) application install restriction,

(d) application uninstall restriction,

(e) SD memory card connection prohibition,

(f) USB memory connection prohibition,

(g) permission of launch of a VPN application,

(h) permission of connection to a WiFi® access point, and

(i) enabling of a proxy (communication with only a set-up proxy server is permitted).

An arbitrary combination of (a) to (i) may be used as an action.

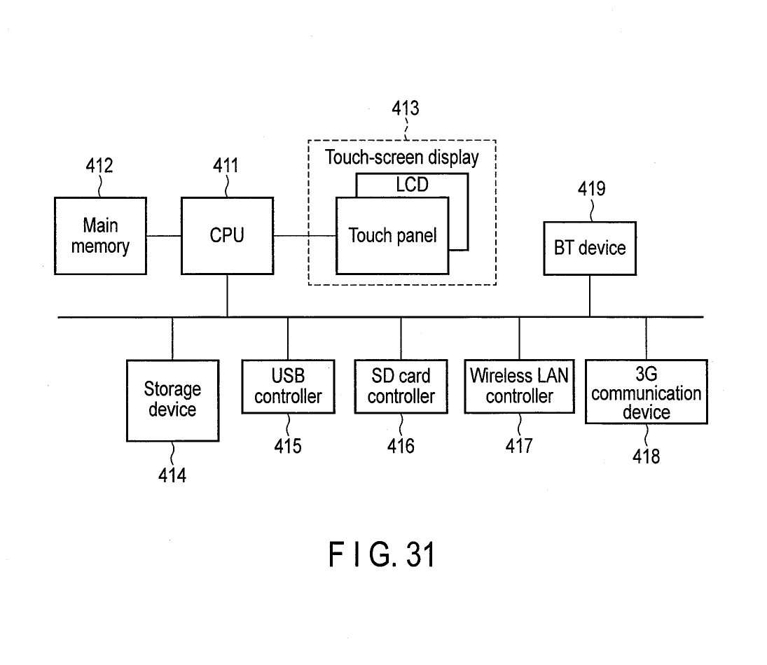

FIG. 31 illustrates a hardware configuration example of the information processing apparatus 1. The information processing apparatus 1 includes a CPU 411, a main memory 412, a touch-screen display 413, a storage device 414, a USB controller 415, an SD card controller 416, a wireless LAN controller 417, a 3 G communication device 418, and a Bluetooth® device (BT device) 419.

The CPU 411 is a processor which controls the respective components in the information processing apparatus 1. The CPU 411 executes various kinds of software, which are loaded from the storage device 414 into the main memory 412, for instance, an OS, an application program, etc. The above-described access detection/control module 10 is executed as a part of the OS.

The management application module 21 and determination application module 22 are realized as different application programs, as described above. An application program corresponding to the management application module 21 may be pre-installed in the storage device 414, as described above.

The application program corresponding to the determination application module 22 is, for example, an application program which is prepared for each company, and determines permission or prohibition of execution of an event according to the determination rule which is suited to the corresponding company. Since the determination application module 22 is a module different from the management application module 21, the determination application conforming to the policy of each company can easily be created.

For example, when the information processing apparatus 1 is used in business work in company A, the determination application module 22 for company A and various application programs for company A may be installed in the information processing apparatus 1. The determination application module 22 for company A may include a rule set for permitting install of each of the various application programs for company A and for prohibiting install of other application programs. Besides, in this rule set, an action of switching enabling/disabling of some other process in accordance with a connection to a certain WiFi® access point in company A may be defined.

In addition, when the information processing apparatus 1 is used in business work of company B, the determination application module 22 for company B and various application programs for company B may be installed in the information processing apparatus 1. The determination application module 22 for company B may include a rule set for permitting install of each of the various application programs for company B and for prohibiting install of other application programs. Besides, in this rule set, an action of switching enabling/disabling of some other process in accordance with a connection to a certain WiFi® access point in company B may be defined.

The touch-screen display 413 is a display which can detect a touch position on the screen, and includes a flat-panel display such as a liquid crystal display (LCD), and a touch panel.

The USB controller 415 is configured to execute communication with a USB device (e.g. USB memory) which is attached to a USB port provided in the information processing apparatus 1. The SD card controller 416 is configured to execute communication with a memory card (e.g. SD card) which is inserted in a card slot provided in the information processing apparatus 1. The wireless LAN controller 417 is a wireless communication device configured to execute wireless communication according to WiFi®, etc. The 3 G communication device 418 is a wireless communication device configured to execute 3G mobile communication. The Bluetooth® device 419 is a wireless communication device configured to execute communication with an external Bluetooth® device.

As has been described above, according to the present embodiment, prior to the execution of an event such as network connection, the content of the event is transmitted from the access detection/control module 10 to the management application module 21. Then, the management application module 21 notifies the content of the event to the determination application module 22 that is the determination program, and transmits the determination result indicative of permission or prohibition of the event, which is received from the determination application module 22, to the access detection/control module 10. In this manner, the permission or prohibition of the event is determined by the determination program (determination application module 22) which is independent from the management application module 21. Accordingly, for example, by preparing the determination program for each company, the permission/prohibition of various events can be determined by using rule sets which are different between companies.

Before an event (first event) of requesting a connection to a specific external communication device is detected by the access detection/control module 10, the management application module 21 transmits, upon receiving an event (second event) of requesting a certain specific process, a first determination result to the access detection/control module 10. However, after the event (first event) of requesting the connection to the specific external communication device is detected by the access detection/control module 10 transmits, the management application module 21, upon receiving the event (second event) of requesting the certain specific process, a second determination result, which is opposite to the first determination result, to the access detection/control module 10. Thus, not only the permission/prohibition of each event can be determined, but it is also possible to easily execute, in accordance with the condition of use or the location of use of the information processing apparatus 1, (a) switching of enabling/disabling of install restriction, (b) switching of enabling/disabling of application launch restriction, (c) addition or change of an IP address and a port number, the connection to which is prohibited, (d) switching of enabling/disabling of application uninstall restriction, (e) switching of enabling/disabling of SD memory card connection restriction or USB memory connection restriction, and (f) switching of enabling/disabling of proxy setup.

In addition, since the environment for restriction of each process is provided by the management application module 21, the configuration of the determination application module 22 can be simplified.

Since the management application module 21 can also be realized by an application program, the update of the management application module 21 itself can easily be executed.

Moreover, the management application module 21 confirms the integrity of the determination application module 22, based on the signature that is given to the determination application module 22, and when the integrity of the determination application module 22 has been confirmed, the management application module 21 identifies this determination application module 22 as the communication counterpart to which the install event information is to be notified. Therefore, the use of a false determination application can surely be prevented.

Besides, the access detection/control module 10 stores the application name of the management application module 21, and identifies, based on this stored application name, the application corresponding to the management application module 21 as the communication counterpart to which the install event information is to be notified. Normally, an application having the same application name as the application that is installed cannot newly be installed. Therefore, it is possible to surely prevent install information from being sent to a false management application module.

In the present embodiment, the description has been given of the case in which the determination rules in the determination application are dynamically changed. However, after a certain event has been detected, the permission or prohibition of each event may be determined based on the determination rules stored in the management application.

In addition, in the present embodiment, the determination application module 22 includes the policy of actions. However, depending on the kinds of actions, the management application module 21 may process actions. In the embodiment, although actions are executed by the access detection/control module 10, to rewrite rules may be defined as an action. For example, a rule that only applications A and B can be launched outside a company may be dynamically changed to a rule that applications C and D can also be launched outside the company if a connection to an intra-company network is established.

All the procedures of the process in this embodiment can be executed by software. Thus, the same advantageous effects as with the present embodiment can easily be obtained simply by installing a computer program, which executes these procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a management module configured to provide an environment for restricting an executable process of the information processing apparatus; and
a controller configured to detect each of a plurality of events comprising a request to connect to any one of a plurality of external communication devices and a request to execute a process other than a request to connect to an external communication device, and to transmit, prior to execution of a process corresponding to a detected event, a content of the detected event to the management module,
wherein the management module is configured to notify the content of the detected event to a determination program, to receive from the determination program a determination result indicative of permission or prohibition of the detected event, and to transmit the determination result to the controller, and
wherein the management module is further configured to (i) transmit, when the detected event comprises a first request to connect to a specific external communication device, a determination result indicative of permission of the connection to the specific external communication device to the controller, to (ii) transmit, when the detected event comprises a second request to execute a specific process and the connection to the specific external communication device is not permitted, a first determination result indicative of one of permission and prohibition of the execution of the specific process to the controller, and to (iii) transmit, when the detected event comprises the second request and the connection to the specific external communication device is permitted, a second determination result indicative of the other of permission and prohibition of the execution of the specific process to the controller.

2. The information processing apparatus of claim 1, wherein a content of a determination result which is received from the determination program with respect to the second request is indicative of said one of the permission and the prohibition of the execution of the specific process when the connection to the specific external communication device is not permitted, and is indicative of said other of the permission and the prohibition of the execution of the specific process when the connection to the specific external communication device is permitted.

3. The information processing apparatus of claim 1, wherein the controller includes a software module in an operating system layer, the management module includes a first application program which is executed in an application layer, and the determination program is executed in the application layer.

4. The information processing apparatus of claim 1, wherein the management module is configured to confirm integrity of the determination program, based on a certificate which is given to the determination program, and to identify, when the integrity of the determination program is confirmed, the determination program as a communication counterpart to which the content of the detected event is to be notified.

5. The information processing apparatus of claim 1, wherein the controller includes a software module in an operating system layer, and the management module includes a first application program which is executed in an application layer, and
the controller is configured to store an application name of the first application program, and to identify, based on the stored application name, the first application program as a communication counterpart to which the content of the detected event is to be notified.

6. The information processing apparatus of claim 1, wherein the specific external communication device is an access point with a specific name or a specific address, or a communication device with a specific address.

7. The information processing apparatus of claim 1, wherein the specific external communication device is an external communication device to which the information processing apparatus is connected via a virtual private network.

8. The information processing apparatus of claim 1, wherein the specific process includes launch of a specific application program.

9. The information processing apparatus of claim 1, wherein the specific process includes install of a specific application program.

10. The information processing apparatus of claim 1, wherein the specific process includes a process of establishing a connection between the information processing apparatus and an external storage device.

11. The information processing apparatus of claim 1, wherein the specific process includes a process of connecting the information processing apparatus to a specific network address.

12. A control method for restricting executable processes of the information processing apparatus, comprising:
detecting each of a plurality of events comprising a request to connect to any one of a plurality of external communication devices and a request to execute a process other than a request to connect to an external communication device;
transmitting, prior to execution of a process corresponding to a detected event, a content of the detected event to a management module configured to provide an environment for restricting a process which the information processing apparatus is permitted to execute; and
outputting a determination result indicative of permission or prohibition of the detected event by the management module inquiring of the determination program about the content of the detected event, wherein
the outputting the determination result comprises:
(i) outputting, when the detected event comprises a first request to connect to a specific external communication device, a determination result indicative of permission of the connection to the specific external communication device;
(ii) outputting, when the detected event comprises a second request to execute a specific process and the connection to the specific external communication device is not permitted, a first determination result indicative of one of permission and prohibition of the execution of the specific process; and
(iii) outputting, when the detected event comprises the second request and the connection to the specific external communication device is permitted, a second determination result indicative of the other of permission and prohibition of the execution of the specific process.

13. The control method of claim 12, wherein a content of a determination result which is received from the determination program with respect to the second request is indicative of said one of the permission and the prohibition of the execution of the specific process when the connection to the specific external communication device is not permitted, and is indicative of said other of the permission and the prohibition of the execution of the specific process when the connection to the specific external communication device is permitted.

14. The control method of claim 12, wherein said detecting the event and said transmitting the content of the detected event are executed by a software module in an operating system layer, and
the management module includes a first application program which is executed in an application layer, and the determination program is executed in the application layer.

15. The control method of claim 12, further comprising:
confirming integrity of the determination program, based on a certificate which is given to the determination program; and
identifying, when the integrity of the determination program is confirmed, the determination program as a communication counterpart to which the content of the detected event is to be notified.

16. The control method of claim 12, wherein said detecting the event and said transmitting the content of the detected event are executed by a software module in an operating system layer,
the management module includes a first application program which is executed in an application layer,
the software module is configured to store a program name of the first application program, and
the control method further comprises identifying, based on the stored application name, the first application program as a communication counterpart to which the content of the detected event is to be transmitted.

17. A computer-readable, non-transitory storage medium having stored thereon a computer program which is executable by a computer, the computer program controlling the computer to execute functions of:
detecting each of a plurality of events comprising a request to connect to any one of a plurality of external communication devices and a request to execute a process other than a request to connect to an external communication device;
transmitting, prior to execution of a process corresponding to a detected event, a content of the detected event to a management module configured to provide an environment for restricting a process which the computer is permitted to execute; and
outputting a determination result indicative of permission or prohibition of the detected event by the management module inquiring of the determination program about the content of the detected event, wherein
the outputting the determination result comprises (i) outputting, when the detected event comprises a first request to connect to a specific external communication device, a determination result indicative of permission of the connection to the specific external communication device, (ii) outputting, when the detected event comprises a second request to execute a specific process and the connection to the specific external communication device is not permitted, a first determination result indicative of one of permission and prohibition of the execution of the specific process, and (iii) outputting, when the detected event comprises the second request and the connection to the specific external communication device is permitted, a second determination result indicative of the other of permission and prohibition of the execution of the specific process.
